(19) United States
(12) Patent Application Publication
(10) Pub. No.: US 2015/0001139 A1
(43) Pub. Date: Jan. 1, 2015

(54) REAL-TIME INTEGRITY MONITORING OF SEPARATION MEMBRANES

(71) Applicant: THE REGENTS OF THE UNIVERSITY OF CALIFORNIA, Oakland, CA (US)

(72) Inventors: Yoram Cohen, Los Angeles, CA (US); Sirikarn Surawanvijit, Los Angeles, CA (US); Anditya Rahardianto, Los Angeles, CA (US); John Thompson, Los Angeles, CA (US)

(21) Appl. No.: 14/318,305

(22) Filed: Jun. 27, 2014

Related U.S. Application Data
(60) Provisional application No. 61/840,420, filed on Jun. 27, 2013.

(51) Int. Cl. G01M 3/20; B01D 61/10

(52) U.S. Cl. CPC G01M 3/20; B01D 61/10
USPC 210/85; 73/40

(57) ABSTRACT

A membrane integrity monitoring system includes: (1) a metering unit fluidly connected to a feed side of a separation membrane unit; (2) a detection unit fluidly connected to a permeate side of the separation membrane unit; and (3) a data acquisition and processing unit connected to the detection unit. The metering unit is configured to inject a fluorescent marker into a feed stream via pulsed dosing. The detection unit is configured to detect a marker signal in a permeate stream. The data acquisition and processing unit is configured to process the marker signal and determine a presence of a membrane breach and at least one of (a) a size of the membrane breach and (b) a location of the membrane breach in the separation membrane unit.

### CROSS REFERENCE TO RELATED APPLICATION

This application claims the benefit of U.S. Provisional Application Ser. No. 61/840,420, filed on Jun. 27, 2013, the content of which is incorporated herein by reference in its entirety.

### TECHNICAL FIELD

This disclosure generally relates to potable water production and water reuse and, more particularly, to integrity monitoring of separation membranes used in potable water production and water reuse.

### BACKGROUND

While reverse osmosis (RO) processes have been shown to be effective in water desalination and removal of materials as small as monovalent ions, membrane integrity breach, however, may render RO processes ineffective for removal of impurities and pathogens. The presence of membrane integrity breaches can result in the passage of harmful impurities and pathogens (e.g., waterborne enteric viruses, Cryptosporidium bacteria, Giardia cysts, nanoparticles, organic compounds, and so forth), which can be in the nanosize range, through RO membranes into the permeate (product) stream and thus pose a significant health threat. The U.S. Environmental Protection Agency (USEPA) has promulgated the Surface Water Treatment Rule (SWTR) and Ground Water Rule (GWR) that mandate 99%, 99.9%, and 99.99% removal or inactivation of Cryptosporidium bacteria, Giardia cysts, and enteric viruses, respectively, in surface and ground water treatment facilities. In addition, the USEPA also mandates the implementation of appropriate and acceptable membrane integrity monitoring techniques for effective monitoring and control of system performance in real-time. Unfortunately, reliable and effective real-time RO integrity monitoring techniques are currently lacking.

It is against this background that a need arose to develop the membrane integrity monitoring system and method described herein.

### SUMMARY

Certain aspects of this disclosure relate to a Pulsed-Marker Membrane Integrity Monitoring (PM-MIMo) system and method. In some embodiments, the PM-MIMo system and method are integrated with membrane-based separations and utilize a fluorescence detection system for real-time monitoring of RO membrane integrity during RO desalination of seawater and brackish water for potable water production, as well as wastewater for water reuse applications. The integration of the PM-MIMo system with RO processes can ensure that harmful contaminants are removed to a level that is appropriate for regulatory purposes thus providing assurance of public health protection.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1 shows the relative size of common waterborne enteric virus capsids (shaded area).

FIG. 2 shows a schematic of a PM-MIMo system implemented according to an embodiment of this disclosure.

FIG. 3 shows examples of marker doses that can be generated by a metering pump as shown in FIG. 2.

FIG. 4 shows a schematic of a spectrofluorometer detection system implemented according to an embodiment of this disclosure.

FIG. 5 shows an example of a flow chart to implement a decision-making process regarding membrane integrity detection and monitoring according to an embodiment of this disclosure.

FIG. 6 shows an arrangement of a plate-and-frame RO system and detection system components used in the evaluation of Example 1.

FIG. 7 shows a spectrofluorometer arrangement used in the evaluation of Example 1.

FIG. 8 shows certain characteristics of uranine used in Example 1.

FIG. 9 shows performance of commercially available polyamide RO membranes used in Example 1.

FIG. 10 shows a table setting forth results of marker rejection by intact membranes of Example 1.

FIG. 11 shows marker transport across a membrane with a breach and associated transport parameters.

FIG. 12 shows results of marker transport characterization in intact membranes of Example 1.

FIG. 13 shows compromised membranes with pinholes used in Example 1, and FIG. 14 shows marker responses for the compromised membranes.

FIG. 15 shows a table listing the values of a reflection coefficient (σ) and a log removal value (LRV) calculated based on the marker responses for the compromised membranes of Example 1 as shown in FIG. 14.

FIG. 16 shows plots of the reflection coefficient (σ) as a function of a total area of membrane breach and as a function of location of breach.

FIG. 17 shows marker transport across membranes with and without breach and associated concentration distribution curves.

FIG. 18 shows Marker Feed Passage and Cumulative Fraction of Marker Passage functions that can be used to represent a concentration distribution curve of a marker.

FIG. 19 shows plots of a fraction (θₜ₁) of a marker that passes through a membrane during a given time period as a function of a total area of membrane breach and as a function of location of breach.

FIG. 20 shows injection of uranine into feed water to achieve a step input according to Example 2.

FIG. 21 shows fluorescent intensity of uranine as a function of breach size.

FIG. 22 shows a plot of the reflection coefficient (σ) as a function of a total area of membrane breach.

FIG. 23 shows a plot of a fraction (θₜ₁) of uranine that passes through a membrane during a given time period as a function of a total area of membrane breach.

FIG. 24 shows a permeate concentration of a fluorescent molecular marker (as represented by its fluorescence intensity) as a function of time for intact and compromised membranes in a plate-and-frame RO membrane system of Example 3.

FIG. 25 shows a permeate concentration of a fluorescent molecular marker (as represented by its fluorescence intensity) as a function of time for intact and compromised membranes in a spiral-wound RO membrane system of Example 3.

FIG. 26 shows a cylindrical pore model used in Example 3.

FIG. 27 shows results of comparison of estimated breach sizes and actual breach sizes for a plate-and-frame RO membrane system of Example 3.

FIG. 28 shows results of comparison of estimated breach sizes and actual breach sizes for a spiral-wound RO membrane system of Example 3.

FIG. 29 shows marker injection into feed water to achieve a step input according to Example 4, and FIG. 30 shows marker responses for an intact membrane and membranes exposed to different concentrations of NaOCl.

FIG. 31 and FIG. 32 show estimation of transport parameters according to Example 4.

FIG. 33 shows effective breach sizes estimated for membranes exposed to different concentrations of NaOCl and for different exposure times of Example 4.

FIG. 34 shows a fraction of marker passage through RO membranes, after a given monitoring period, at distances of (top) about 4 cm and (bottom) about 5.5 cm from a channel entrance for different membrane breached areas. A plate-and-frame RO system was operated at about 100 psi at a cross flow velocity of about 18.4 cm/s. Uranine dosing was set to attain a concentration of about 40 ppm in the RO feed for a duration of about 60 s.

FIG. 35 shows a relationship between a fraction of total marker passage through a membrane with a total area of membrane integrity breach. Conditions included: monitoring period of about 5 min from a commencement of marker feed injection, and about 60 sec of marker injection to achieve about 40 ppm marker RO feed concentration.

FIG. 36 shows marker feed passage (MFP) at various monitoring times. A spiral-wound RO system was operated at about 160 psi at a cross flow velocity of about 12.12 cm/s. Uranine dosing was set to attain about 20 ppm concentration in the RO feed stream for a pulse duration of about 2 min.

FIG. 37 shows a fraction of total marker passage through RO membranes at various monitoring times. A spiral-wound RO system was operated at about 160 psi at a cross flow velocity of about 12.12 cm/s. Uranine dosing was set to attain a concentration of about 20 ppm in the RO feed stream for a pulse duration of about 2 min.

FIG. 38 shows a PM-MIMo scheme of Example 6.

FIG. 39 shows a schematic of a spiral-wound RO (SPRO) membrane system with a marker detection system connected to a side stream (S) of the combined permeate stream (P). F1, C1, and P1 are the feed, retentate, and permeate streams of the first SPRO module, respectively. F2, C2, and P2 are the feed, retentate, and permeate streams of the second SPRO module, respectively. Note: permeate monitoring also can be carried out separately from each of the pressure vessels.

FIG. 40 shows the impact of marker feed dose and reflection coefficient on marker concentration in a permeate stream of a plate-and-frame RO (PFRO) system of Example 6. Cₚ was determined from Eq. 20 with k_{f}=4.9×10⁻⁵ m/s, B=1.24×10⁻¹⁰, and Jᵥ=9.33×10⁻⁶ m/s.

FIG. 41 shows marker concentration-time profiles for the RO permeate for compromised membranes with various breached sizes, in response to a marker pulse input of about 20 ppm, about 30 ppm, about 40 ppm, as well as for continuous marker input of about 40 ppm. The PFRO system was operated at about 100 psi and a cross flow velocity of about 18 cm/s; Uranine pulse had a duration of about 60 seconds.

FIG. 42 shows the impact of membrane breach area on the reflection coefficient as determined from Eq. 20. k_{f} and B were pre-determined experimentally using Eq. 22, and have the values of 4.9×10⁻⁵ m/s and 1.24×10⁻¹⁰ m/s, respectively. Uranine dosing was set to attain a constant marker feed concentration of about 40 ppm. The PFRO system was operated at about 100 psi and a cross flow velocity of about 18 cm/s.

FIG. 43 shows RO permeate marker fluorescence intensity-time profiles in response to marker injection into the SPRO feed for different sizes and locations of membrane breaches. The SPRO system was operated at about 160 psi at a cross flow velocity of about 12 cm/s. Uranine dosing was set to attain SPRO marker feed concentration of about 20 ppm for a pulse duration of about 60 s.

FIG. 44 shows the marker feed passage (MP) (Eq. 27) at various monitoring times for the SPRO system with a compromised first module. The SPRO system was operated at about 160 psi at a cross flow velocity of about 12 cm/s. Uranine dosing was set to attain RO feed concentration of about 20 ppm for a pulse duration of about 60 s.

FIG. 45 shows the cumulative fraction of marker passage (CFMP) to the permeate stream (Eq. 15) as a function of time for the SPRO membrane with a breach area of (a) about 0.8 mm² and (b) about 1.6 mm². The SPRO system was operated at about 160 psi at a cross flow velocity of about 12 cm/s. Uranine dosing was set to attain an RO feed concentration of about 20 ppm for a pulse duration of about 60 s. t=0 represents the starting time of the marker permeate response.

FIG. 46 shows the time to reach a fraction of total marker passage (CFMP) (Eq. 29) of 50% for membranes with various breached areas in either the first or second SPRO element.

FIG. 47 shows the total marker concentration in the permeate stream in response to marker LRV due to convection of the SPRO membrane system. The SPRO system is operated at about 160 psi feed pressure and a cross flow velocity of about 12 cm/s with uranine RO feed concentration of about 20 ppm in the SPRO feed for a pulse period of about 1 minute. Total permeate concentration for a given LRV due to convective transport was calculated using Eq. 24c.

FIG. 48 shows the amount of marker used for membrane integrity monitoring for an about 60-second pulse input of about 40 ppm of marker for various dosing frequencies for three different RO feed capacities.

### DETAILED DESCRIPTION

### Overview

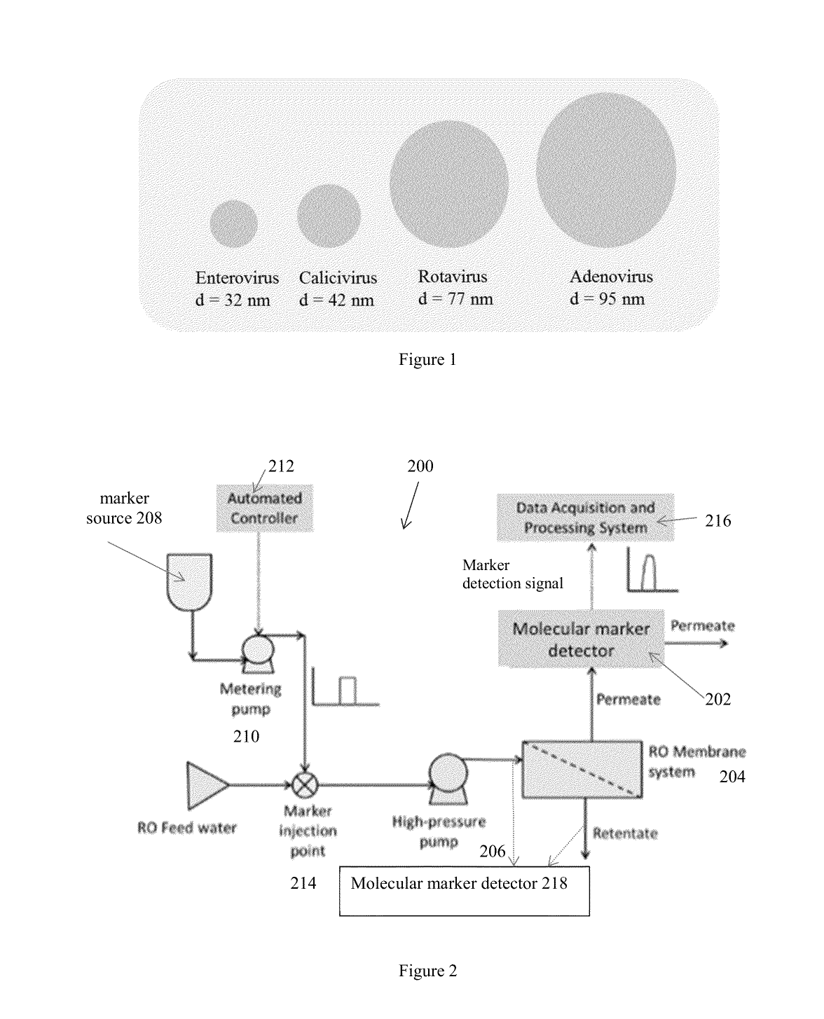

Monitoring and control of pathogens in water treatment processes is a daunting challenge for the water industry and governmental regulators. Of the different pathogens (e.g., bacteria, viruses, and other parasites), waterborne viruses are especially challenging given their small size, high mobility, and resistance to chlorination. Waterborne enteric viruses have been linked to a variety of diseases, including poliomyelitis, heart disease, encephalitis, aseptic meningitis, hepatitis, gastroenteritis, and even paralysis in immune-compromised individuals. Enteric viruses, which are nucleic acid strands surrounded by protein protective coats (capsids), are obligate intracellular parasites, infecting host cells in order to replicate. In the absence of host cells, enteric viruses are essentially inert nanoparticles, commonly in the size range of about 30 nm to about 100 nm (see FIG. 1).

Pressure-driven membrane processes can be integrated as part of a multi-barrier water treatment approach to safeguard water supplies against harmful pathogens and impurities. Low pressure membrane (LPM) processes, such as microfiltration (MF) and ultrafiltration (UF), typically provide a barrier for particles larger than about 0.1-10 μm and larger than about 0.005-0.05 μm, respectively. High pressure membrane (HPM) processes such as nanofiltration (NF) typically can reject multivalent ions and materials larger than about 0.0005-0.001 μm, while RO typically can reject materials as small as monovalent ions. LPM processes such as UF can be effective in the rejection of pathogens as small as enteric viruses, given the typical size of enteric viruses (about 30-100 nm). Also, HPM processes, such as RO and NF, can provide a barrier to pathogens as small as nanosized enteric viruses. Membrane and membrane module imperfections or damage, however, may render both LPM and HPM processes ineffective for pathogen removal.

Accurate and continuous or even semi-continuous real-time monitoring of membrane integrity is of importance in membrane technology applications and for regulatory compliance for membrane applications in water and wastewater treatment and desalination. Even small membrane integrity breaches (e.g., pinholes) can lead to product water contamination thereby posing significant health threat. Membrane integrity breaches may be the result of numerous factors that include manufacturing defects, faulty installation and maintenance, chemical attacks (e.g., oxidation, such as resulting from exposure to chlorine or other chlorinated species), insufficient or improper pre-treatment or pre-filtration, failure of assembly components (e.g., O-rings), and operational damage that can occur due to various factors such as water hammer, passage of sharp debris, and cleaning of fouled or scaled membranes. From an operational viewpoint, there is a need to identify the occurrence, location, and extent of a membrane breach in sufficient time to allow corrective actions, avoid plant downtime, and ensure public health protection and regulatory compliance.

The USEPA's SWTR specifies regulations for the removal or inactivation of pathogens (e.g., disease-causing microorganisms that include bacteria, viruses, and parasites) from surface water systems. These regulations are based on the metric of the Log Removal Value (LRV):

$$LRV = {log}_{10} ( \frac{{C}_{j}}{{C}_{p}} ) \qquad ( 1 )$$

in which C_{f} is the concentration of a pathogen in a feed stream, and Cₚ is the pathogen concentration in the permeate product stream.

Under the SWTR, the LRV in water treatment processes are regulated as follows:

99% (2-log) removal or inactivation of Cryptosporidium

99.9% (3-log) removal or inactivation of Giardia

99.99% (4-log) removal or inactivation of viruses

For recycled water treatment, regulations vary by state. In California, 4-log removal or inactivation of Cryptosporidium and 99.999% (5-log) removal or inactivation of viruses are specified for disinfected recycled water.

To address these challenges and regulatory environment, embodiments of this disclosure are directed to a PM-MIMo system and approach to monitor RO membrane integrity by:

i) detecting the presence of membrane integrity breach (e.g., as small as the nanosize range) in real-time through monitoring instances of a desired frequency;

ii) deriving estimates on the size of the membrane integrity breach or the effective or corresponding breach size for breaches that are unconventional (e.g., other than pinholes, such as resulting from oxidation of membrane surface, cracked O-ring, broken membrane seals, and so forth); and

iii) deriving estimates of the passage potential of various pathogens (e.g., enteric viruses, Cryptosporidium bacteria, and Giardia cysts) as well as other contaminants of concern (e.g., nanoparticles, organic compounds, and so forth) through intact and compromised membranes. Although certain embodiments are described as follows in the context of RO processes, the PM-MIMo system and method can be extended to other HPM processes as well as LPM processes.

FIG. 2 shows a schematic of a PM-MIMo system 200 implemented in the context of a water treatment system according to an embodiment of this disclosure. The PM-MIMo system 200, which is installed in-line with RO feed and permeate streams, includes a detector (or a detection system) 202 to monitor in real-time the emergence of a marker in the permeate stream due to a membrane breach. The detector 202 can be, for example, a spectrofluorometer system (or unit to monitor a fluorescent marker) that is fluidly connected to a permeate side of a RO membrane system (or unit) 204 to receive the permeate stream. The RO feed stream is supplied to a feed side of the RO membrane system 204 through a high-pressure pump 206. The RO feed stream can be pre-treated to reduce the potential of membrane fouling by organics and colloids, as well as bio-fouling during membrane-based desalting, such as using UF or NF processes. It is noted that additional in-line marker detectors 218, such as additional spectrofluorometer or other suitable systems (or units to monitor membrane breaches via infrared spectroscopy, mass spectrometry, or other techniques), can be fluidly connected to either of, or both, the feed and concentrate side of the RO membrane system 204 in order to monitor the marker concentration in either of, or both, the feed and concentrate streams by the PM-MIMo system 200. It is also contemplated that the detection system 202 can be fluidly connected to either of, or both, the feed and concentrate side of the RO membrane system 204 (in addition to the permeate stream) through a multiplexer, such that additional in-line detection systems can be omitted.

As shown in FIG. 2, the PM-MIMo system 200 also includes a source of a molecular marker 208 and a dosing unit 210 (e.g., a precision metering pump), which are fluidly connected to the feed side of the RO membrane system 204. An automated controller 212 is connected to the precision metering pump 210, and controls (e.g., activates and deactivates) operation of the pump 210 to apply pulsed dosing of the molecular marker into the feed stream at a marker injection point 214. This pulsed dosing is carried out in combination with (near) real-time monitoring of marker concentration in the permeate stream by the in-line detection system 202.

A data acquisition and processing system (or unit) 216 is connected to the detection system 202, and processes marker signals detected by the spectrofluorometer system 202 to infer membrane integrity or its loss based on (near) real-time analysis of a dynamic change in marker concentration in the permeate stream, in response to the controlled change in the marker feed concentration. The data acquisition and processing system 216 also determines the extent of membrane integrity loss (e.g., the size of a breach) as well as determines the extent of pathogen and contaminant passage through a RO membrane in (near) real-time. The automated controller 212 can be implemented in hardware, software, or a combination of hardware and software. Similarly, the data acquisition and processing system 216 can be implemented in hardware, software, or a combination of hardware and software. Although the automated controller 212 and the data acquisition and processing system 216 are shown separately in FIG. 2, these components can be integrated together in other embodiments.

The PM-MIMo system 200 can be integrated with, or otherwise incorporated into, RO membrane processes for seawater and brackish water desalination, wastewater treatment, as well as drinking water production. In addition to the various capabilities of the PM-MIMo system 200 for RO membrane integrity monitoring, the system 200 is also practical and cost-efficient for integration with full-scale RO plants, and provides benefits resulting from one or more of the following characteristics:

i) Cost effective: In the case of the use of fluorescent molecular markers, such markers can be selected from inexpensive and commercially available markers. In addition, the PM-MIMo system 200 reduces marker consumption since markers are dosed into the RO feed stream in short pulses.

ii) Ease of operation and assembly: The molecular markers can be selected to avoid special handling and storage. Typically, the in-line detection system 202 can be implemented with modular components for ease of assembly.

iii) Flexibility for scale-up: The PM-MIMo system 200 can be adapted for RO plants of various capabilities.

iv) Capable to treat various types of water: The type and concentration of molecular markers, as well as the marker detection setup, can be tailored to comply with pertinent regulatory specifications for treatment of various types of water (e.g., seawater, brackish water, ground water, wastewater, drinking water, and so forth).

v) Minimal or reduced use of hazardous or toxic chemicals: Molecular markers (e.g., fluorescent markers) can be selected as those that are non-toxic.

vi) Provide great sensitivity: The PM-MIMo system 200 can be implemented to detect molecular markers at low concentrations. For example, a spectrofluorometer can detect certain fluorescent markers at a concentration level as low as one or a few parts-per-billion (ppb) or even as low as one or a few parts-per-trillion (ppt), and therefore provide sufficient sensitivity and resolution (e.g., rejection level greater than about 99.99%). Such detected low concentrations can result from, for example, a single breach within a full-scale membrane train.

vii) Monitoring membrane integrity in (near) real-time: The use of the in-line spectrofluorometer system 202 allows the assessment of membrane integrity characteristics in (near) real-time, which allows fast corrective actions to ensure public health protection while minimizing or reducing plant downtime. Normal filtration operations of the plant can continue during membrane integrity monitoring.

viii) Comprehensive monitoring: The PM-MIMo system 200 can determine the extent (e.g., size) of a breach as well as the location of the breach to facilitate corrective action. In some implementations, a breach size can be determined to within about 1% to about 20% accuracy of an actual breach size (i.e., accurate to within about 80% to about 99%), such as within about 1% to about 15% (i.e., accurate to within about 85% to about 99%), within about 1% to about 10% (i.e., accurate to within about 90% to about 99%), within about 1% to about 8% (i.e., accurate to within about 92% to about 99%), within about 1% to about 7% (i.e., accurate to within about 93% to about 99%), or within about 5% to about 7% (i.e., accurate to within about 93% to about 95%). The PM-MIMo system 200 can derive characteristics of a membrane integrity breach, and, based on these characteristics, the PM-MIMo system 200 can assess or derive the passage potential of pathogens and contaminants through a compromised membrane, which is a main concern in ensuring public health protection. As explained further below (see, for example, Example 3), a framework is developed to estimate the size of a membrane integrity breach (e.g., represented as a pinhole) or an effective or corresponding breach size for breaches that are unconventional, as well as to estimate the passage potential (e.g., in terms of rejection or a LRV) of various pathogens and contaminants through a membrane with varying extents of integrity breaches. This framework can be integrated with the data acquisition and processing system 216 as shown in FIG. 2. Therefore, comprehensive information on membrane integrity breach characteristics and contaminant passage potential can be obtained in (near) real-time.

### Fluorescent Molecular Markers

One benefit of a PM-MIMo system of some embodiments is the use of fluorescent molecular markers, which can be inexpensive, non-toxic, and commercially available, and do not involve special handling. Although various molecular markers can be used with the pulsed marker approach, the use of low cost fluorescent molecular markers has a particular advantage as it allows the PM-MIMo system to be practical for full-scale applications. Also, the PM-MIMo system can detect fluorescent markers at high sensitivity and resolution. The high sensitivity of the PM-MIMo system can result from one or more of:

i) The PM-MIMo system can include a high-sensitivity detection system, such as a spectrofluorometer, that can detect as low as ppb (or even lower) levels of markers.

ii) When using a spectroflurometer for detecting and monitoring the concentration of fluorescent molecular markers, an emission spectrum of selected markers can be rather different from an emission spectrum of contaminants that naturally fluoresce in surface and ground water. The above is advantageous since it results in a significant difference in a marker fluorescence intensity and a background fluorescence intensity.

iii) In the PM-MIMo approach, markers are dosed into a RO feed stream in a pulse mode. Marker pulsing allows for the use of higher marker feed concentration for a shorter duration to attain enhanced marker response for RO membranes, at sufficiently high levels of detection, in the RO permeate, while reducing marker consumption (relative to a constant rate marker dosing) and increasing capability of marker detection and thus heightened sensitivity for membrane breach detection and characterization.

Examples of suitable molecular markers include fluorescent molecular dyes, such as those listed in Table 1 below.

TABLE 1

| | Ex/Em^{(a)} | | Molecular | Solubility in |
|---|---|---|---|---|
| Fluorescent Dyes | (nm) | Chemical Formula | Weight | Water (mg/mL) |
| Rhodamine WT | 554/580 | C₂₉H₂₉N₂NaO₅ | 480.55 | very soluble |
| Rhodamine B | 554/576 | C₂₈H₃₃ClN₂O₃ | 479.02 | 50 |
| Rhodamine 6G | 526/552 | C₂₈H₃₁ClN₂O₃ | 497.02 | 20 |
| Sulforhodamine B | 554/576 | C₂₇H₂₉N₂NaO₇S₂ | 580.65 | 10 |
| Amidorhodamine G | 530/551 | C₂₅H₂₅N₂NaO₇S₂ | 552.59 | very soluble |
| Fluorescein | 490/520 | C₂0H₁₂O₅ | 332.31 | 0.3 |
| Uranine | 491/512 | C₂₀H₁₀Na₂O₅ | 376.28 | 40 |
| Eosin B | 516/538 | C₂₀H₆Br₄Na₂O₅ | 691.88 | 40 |
| Pyranine | 455/512 | C₁₆H₇Na₃O₁₀S₃ | 524.39 | 178 |
| Tinopal CBS-X | 346/435 | C₂₈H₂₆Na₂O₆S₂ | 562.57 | 25 |
| Erythrosine | 525/547 | C₂₀H₆I₄Na₂O₅ | 879.87 | 20 |
| Sodium naphtionate | 320/430 | C₁₉H₈NNaO₃S | 245.23 | 240 |
| Lanaperl fast yellow | 469/508 | C₂₅H₂ON₅NaO₄S₂ | 549.55 | very soluble |
| Lissamine FF | 432/508 | C₁₉H₁₃N₂NaO₅S | 404.38 | 40 |
| Bengal rose | 518/535 | C₂₀H₂Cl₄I₄Na₂O₅ | 1017.67 | 100 |
| Fluorescent brightener 28 | 349/430 | C₄0H₄₂N₁₂Na₂O₁₀S₂ | 960.96 | very soluble |

^{(a)}Ex/Em: Fluorescence excitation (Ex) and emission (Em) peaks.

Additional examples of fluorescent molecular dies include amidoflavine, lissamine green B, photine CU, amino G acid, and leucophor PBS. In some embodiments, one type of fluorescent molecular dye is used for membrane integrity monitoring, and, in other embodiments, a combination of two or more different types of fluorescent molecular dyes are used for membrane integrity monitoring.

Fluorescent molecular dyes used for membrane integrity monitoring in water treatment and desalination applications can be selected according to criteria such as readily water soluble, stable, detectable at low concentration, non-toxic, biocompatible, environmentally friendly, and readily available. Such dyes should also undergo little or no chemical reactions with a membrane material, and with little or no adsorption onto a membrane surface or absorption into the membrane material itself.

Although certain embodiments are described in the context of fluorescent molecular dyes, the PM-MIMo system and approach can be extended to other markers, such as fluorescent-tagged bacteriophages, fluorescent-tagged nanoparticles, and fluorescent-tagged macromolecules, as well as non-fluorescent markers that can be detected by a range of detectors (e.g., ultraviolet and infrared spectrometers as well as mass spectrometers).

### Additional Aspects and Operation of PM-MIMo System

A PM-MIMo system of some embodiments monitors the integrity of RO membranes in real-time, at the desired frequency of marker dosing frequency, for estimation of passage potential of harmful pathogens and contaminants. RO feed water can be, for example, brackish or contaminated water in natural environments, wastewater (e.g., industrial, agricultural, municipal, mining, and so forth), or seawater. Markers can be, for example, any type of marker that can be detected by a marker detector. In particular, fluorescent molecular dyes are suitable that are non-toxic, inexpensive, commercially available, and exhibit a strong fluorescent signal at a desired level of sensitivity. The sensitivity of the PM-MIMo system and its mode of operations can be tailored to comply with varying contaminants of concern, as well as pertinent environmental regulations or end user specifications. Benefits of the PM-MIMo system include providing a high sensitivity of detection of marker passage through RO membranes in real-time, at the desired frequency of marker dosing frequency, detecting the presence of membrane integrity breaches (e.g., as small as the nanosize range), providing information on characteristics of the membrane integrity breach (e.g., the size of the membrane integrity breach or the effective or corresponding breach size for the type of breaches that are unconventional), and estimating the passage potential of various pathogens (e.g., enteric viruses, Cryptosporidium bacteria, and Giardia cysts) as well as other contaminants of concern (e.g., nanoparticles, organic compounds, and so forth) through intact and compromised membranes. The PM-MIMo system can be integrated and operated in full-scale water treatment plants to ensure compliance with regulatory specifications.

Referring to FIG. 2, aspects of the PM-MIMo system 200 can include:

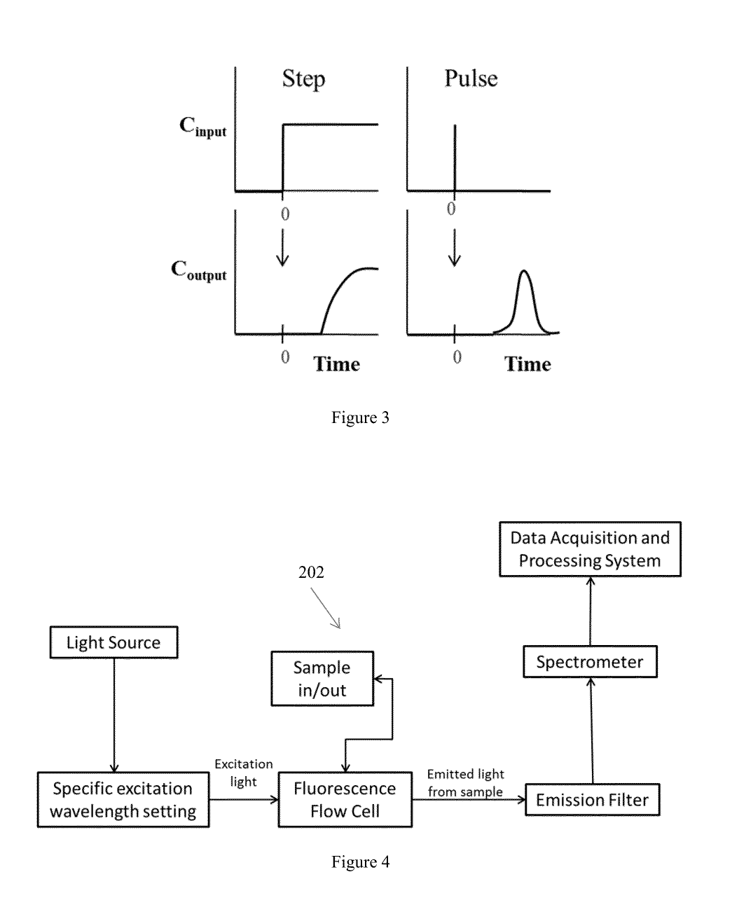

i) An in-line injection of a marker solution into the RO feed stream using the high-precision metering pump 210 to introduce controllable marker pulses into the RO feed stream: The marker injection point 214 is located upstream of the high-pressure pump 206 in order to ensure sufficient mixing of the marker solution and the RO feed stream. The metering pump 210 is controlled by the automated controller 212 (e.g., a model-based process controller), which is configured to generate a variety of metering pump outputs that vary in marker concentration in the feed stream (e.g., from about 0.1 ppb to about 100 parts-per-million (ppm, mg/L), from about 0.2 ppb to about 100 ppm, from about 0.1 ppm to about 100 ppm, from about 1 ppm to about 100 ppm, from about 2 ppm to about 100 ppm, from about 3 ppm to about 100 ppm, from about 5 ppm to about 100 ppm, from about 10 ppm to about 100 ppm, from about 15 ppm to about 100 ppm, from about 20 ppm to about 100 ppm, from about 1 ppm to about 80 ppm, from about 2 ppm to about 80 ppm, from about 3 ppm to about 80 ppm, from about 5 ppm to about 80 ppm, from about 10 ppm to about 80 ppm, from about 15 ppm to about 80 ppm, from about 20 ppm to about 80 ppm, from about 1 ppm to about 60 ppm, from about 2 ppm to about 60 ppm, from about 3 ppm to about 60 ppm, from about 5 ppm to about 60 ppm, from about 10 ppm to about 60 ppm, from about 15 ppm to about 60 ppm, from about 20 ppm to about 60 ppm, from about 1 ppm to about 40 ppm, from about 2 ppm to about 40 ppm, from about 3 ppm to about 40 ppm, from about 5 ppm to about 40 ppm, from about 10 ppm to about 40 ppm, from about 15 ppm to about 40 ppm, from about 20 ppm to about 40 ppm, from about 1 ppm to about 20 ppm, from about 2 ppm to about 20 ppm, from about 3 ppm to about 20 ppm, from about 5 ppm to about 20 ppm, from about 10 ppm to about 20 ppm, or from about 15 ppm to about 20 ppm at maximum or peak concentration, or at least about 3 ppm, at least about 5 ppm, at least about 10 ppm, at least about 15 ppm, or at least about 20 ppm at maximum or peak concentration), number of pulses (e.g., 1, 2, 3, 4, 5, or more pulses during a given time period, such as 24 hr, 12 hr, 6 hr, 3 hr, 1 hr, or 0.5 hr), frequency of pulses (e.g., at least one pulse per 24 hr, per 12 hr, per 6 hr, per 3 hr, per 1 hr, or per 0.5 hr), duration of pulses (e.g., from about 0.1 min to about 20 min, from about 0.1 min to about 15 min, from about 0.1 min to about 12 min, from about 0.1 min to about 10 min, from about 0.1 min to about 8 min, from about 0.1 min to about 6 min, from about 0.1 min to about 4 min, from about 0.1 min to about 2 min, or from about 0.1 min to about 1 min in terms of a time period during which the metering pump 210 is activated or in terms of a time period between 50% points of maximum or peak concentration of a pulse, or a non-zero value of about 20 min or less, about 15 min or less, about 12 min or less, about 10 min or less, about 8 min or less, about 6 min or less, about 4 min or less, or about 2 min or less in terms of a time period during which the metering pump 210 is activated or in terms of a time period between 50% points of maximum or peak concentration of a pulse), time between pulses (e.g., about 5 min or greater, about 10 min or greater, about 15 min or greater, about 20 min or greater, about 25 min or greater, about 30 min or greater, or about 1 hr or greater), as well as dosing modes (e.g., pulse versus step input). The ability to adjust the characteristics of metering pump outputs can allow multiple modes of monitoring that can be optimized towards specific monitoring objectives (e.g., early membrane breach detection versus membrane performance verification). Some examples of marker doses that can be generated by the metering pump 210 are illustrated in FIG. 3. FIG. 3(a) illustrates two examples of stepped dosing (one with a sharply rising profile and another with a gradually rising profile), while FIG. 3(b) illustrates two examples of pulsed dosing (one with a narrow pulse duration similar to a Dirac pulse and another with a wider pulse duration similar to a Gaussian pulse). Additional examples of pulsed dosing include dosing according to rectangular pulses, Nyquist pulses, and cosine squared (raised cosine) pulses. It should be noted that stepped dosing with a finite duration also can be referred to as pulsed dosing. In the case that the RO feed water includes a relatively high concentration of chlorine (e.g., >5 mg/L), it may be desirable to de-chlorinate the RO feed water prior to marker injection, since chlorine can quench fluorescent signals of some fluorescent molecular markers. De-chlorination can be performed by injecting a de-chlorinating agent, such as sodium metabisulfite, ascorbic acid, or both, upstream of the marker injection point 214. In some cases, it may be desirable to install additional marker detection systems for monitoring marker concentrations in either of, or both, the RO feed and concentrate streams to allow the PM-MIMo system 200 to detect any quenching of marker signals (e.g., due to the effect of chlorinating or other quenching agents). In some cases, a positive indication of a membrane breach based on a marker response in the permeate stream due to a marker pulse in the feed stream is utilized to trigger a subsequent marker pulse with a higher marker concentration than the first pulse in order to confirm the positive indication of the membrane breach.

ii) An in-line marker detection system 202, such as using a spectrofluorometer that is installed in-line with the RO feed and permeate streams: FIG. 4 shows a schematic of the detection system 202 implemented according to an embodiment of this disclosure. The detection system 202 can include, for example, commercially available submersible or in-line fluorometers (for detection of fluorescent markers) that can measure and provide fluorescence intensity data (e.g., for a given excitation and emission wavelengths) as analog or digital signals to the data acquisition and processing system 216. In some cases, when a spectrofluorometer system is used, it can be assembled from modular components, and includes a light source, optical filters (excitation and emission filters), a fluorescence flow cell, and a spectrometer, which is connected to the data acquisition and processing system 216 shown in FIG. 2. The components of the detection system 202 are connected to each other via optical fibers or other transmission media. The light source can be, for example, a xenon lamp or a light emitting diode (LED), depending on a desired sensitivity. One optical filter is placed after the light source to focus the light from the light source to an excitation spectrum of a selected marker, while the other optical filter is placed after the flow cell to sharpen an emission spectra of the sample. After passing through the excitation optical filter, the excitation light enters the fluorescence flow cell, which allows RO feed or permeate water to flow through. The size of the flow cell can be tailored to accommodate a target flow rate from the RO membrane system 204. Fluorescence from the sample is emitted to the spectrometer, where the emitted light intensity can be quantified in a relative unit referred to as “counts.” In this stage of operation, a fluorescence spectra as well as the light intensity at the emission wavelength can be recorded by the data acquisition and processing system 216 in real-time.

iii) The data acquisition and processing system 216 operates to acquire, process, and record the marker detector's data in real-time: Functionalities of this system 216 (applicable for any type of molecular marker detector) include one or more of the following:

a. Collecting data from the detection system 202 (e.g., fluorescence intensity data).

b. Converting the data (e.g., fluorescence intensity data) to marker concentration using a concentration-intensity calibration curve (e.g., developed prior to RO runs).

c. Determining the presence of a membrane integrity breach via (%) marker rejection as well as residence time distribution (RTD) analysis (also referred to as a marker passage time distribution (MPTD) analysis), such as further explained in the examples below.

d. Estimating the size of the membrane integrity breach via a cylindrical pore model, such as further explained in the examples below.

e. Estimating the passage potential of contaminants of concern in terms of (%) rejection, their concentration in the permeate stream, or both.

f. Normalizing the analysis in operations (c) to (e) with respect to actual marker concentration in either of, or both, the feed and concentrate streams, if additional marker detection systems are fluidly connected to the RO feed and/or concentrate streams. This optional operation can allow detection of marker signal (e.g., marker fluorescence) quenching.

g. Recording the data generated in operations (a) to (f).

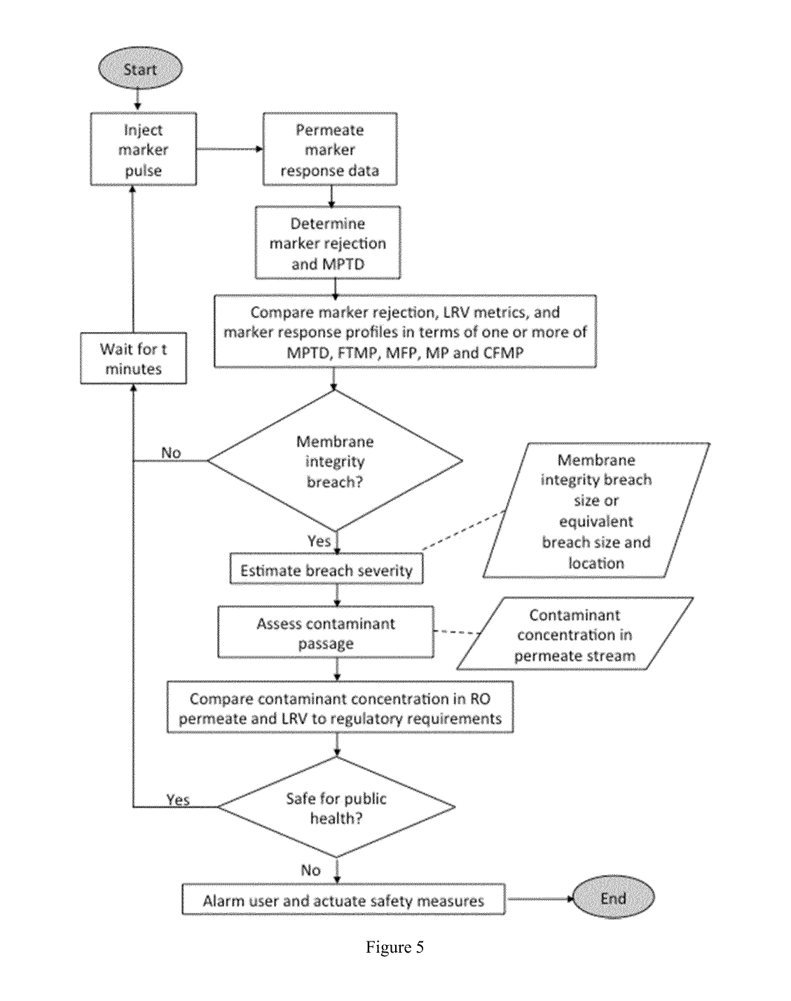

Using the generated data coupled with regulations or end user specifications, a decision can be made (e.g., by a user or in an automated manner) as to whether the RO product water is safe for public health and whether any corrective actions should be made (e.g., replacement or maintenance of membranes, membrane modules, O-rings, and so forth). Such decision-making process can also be integrated with the data acquisition and processing system 216 shown in FIG. 2 to implement the PM-MIMo approach in large-scale RO plants. An example of a flow chart to implement the decision-making process is shown in FIG. 5.

Referring to FIG. 2, operation of the PM-MIMo system 200 can include:

i) A baseline performance of intact RO membranes is established, such as membrane permeability, salt rejection, and marker rejection under various RO conditions. This operation can be performed when new membranes or new membrane modules are installed in the RO membrane system 204.

ii) A molecular marker solution is injected periodically, for example, every about 10 to about 30 minutes or every few hours, depending on specified regulations and marker cost, into the RO feed stream during a normal RO plant operation. The marker can be injected in a short pulse (e.g., a pulse duration up to about 1-2 minutes) in order to reduce marker consumption. The dosing flow rate (Q_{D}) of the marker feed solution of concentration (C_{D}) to achieve a target dosing marker concentration (C_{F}) in the RO feed stream can be calculated from:

$${Q}_{D} = \frac{{Q}_{F} {C}_{F}}{{C}_{D} - {C}_{F}} \qquad ( 2 )$$

which can be derived based on a marker mass balance around the injection point 214, and where Q_{F} is the RO feed stream flow rate. The marker concentration should be high enough to raise the marker permeate response to detectable levels.

iii) The RO feed and permeate streams are allowed to flow through a marker detection flow cell (e.g., as shown in FIG. 4 in order for the spectrometer to acquire fluorescence intensity data). In cases where the flow rates of the RO feed and permeate streams exceed the capability of the flow cell, side streams can be added to both RO feed and permeate streams in order to divert a fraction of the feed and permeate streams to the flow cell.

iv) The molecular marker detector's data are recorded and processed by the data acquisition and processing system 216, which derives information including marker rejection, indication of the presence of a membrane integrity breach, a membrane integrity breach size, and a pathogen or contaminant rejection.

v) Using the above information and regulatory or user specifications, the decision-making process as shown in FIG. 5 is used to determine whether the RO product water is safe for public health and whether any corrective actions should be made.

vi) In the case of full-scale RO plants, which can include multiple RO membrane modules, additional information regarding the location of a breach can be obtained by monitoring specific modules or RO stages individually. Such monitoring can be performed by integrating the PM-MIMo system 200 with a multiplexer, or by integrating multiple PM-MIMo systems corresponding to the multiple RO membrane modules.

In other embodiments, operation of the PM-MIMo system 200 can leverage a correlation between marker responses in a permeate stream and characteristics of membrane breaches (e.g., in terms of either of, or both, size and location). For example, a profile or shape of a marker concentration distribution curve in a permeate stream can be dependent upon and can be correlated to the presence and characteristics of a membrane breach. Also, one or more of a LRV, transport parameters, and a RTD of the marker can be dependent upon and can be correlated to the presence and characteristics of a membrane breach. For a marker dosing having given characteristics, a set of reference marker responses in the permeate stream can be generated for intact membranes and compromised membranes with various membrane breach characteristics. During operation of the PM-MIMo system 200, a marker response can be detected and derived in the permeate stream, and the detected marker response can be compared with the reference marker responses. By identifying a reference marker response as a match or a closest match, the presence of a membrane breach can be determined, and characteristics of the membrane breach can be determined as corresponding to those of the reference marker response.

### EXAMPLES

The following examples describe specific aspects of some embodiments of this disclosure to illustrate and provide a description for those of ordinary skill in the art. The examples should not be construed as limiting this disclosure, as the examples merely provide specific methodology useful in understanding and practicing some embodiments of this disclosure.

### Example 1

This example describes the evaluation of a marker-based approach to monitor the passage of detectable fluorescent molecular markers through RO membranes. Advantages of the approach include high-sensitivity monitoring and characterization of membrane integrity without affecting feed water quality. As described in the following, marker responses in the permeate (e.g., one or more of a marker concentration distribution curve in the permeate, a LRV, transport parameters, and a RTD) can be correlated to characteristics of membrane breaches (e.g., in terms of either of, or both, size and location).

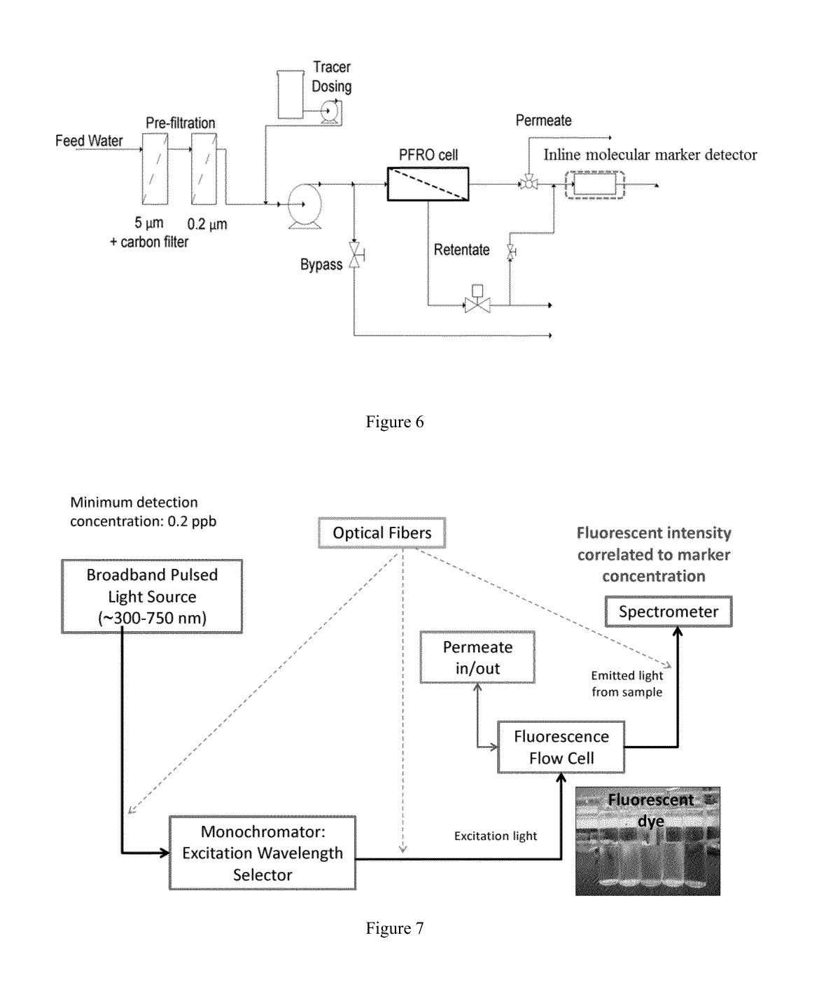

FIG. 6 shows a plate-and-frame RO (PFRO) system used in the evaluation. Feed water is fed to a PFRO cell through a pair of pre-filtration units and a pump. Marker dosing is applied to the feed stream to introduce the fluorescent molecular markers, and an in-line spectrofluorometer is used to monitor marker responses in either of, or both, the permeate stream and the retentate stream. A size of the membrane coupon was about 1.2 inches by about 3.1 inches, a permeate recovery was less than about 1%, and the water source is tap water.

FIG. 7 shows the spectrofluorometer used in the evaluation. A broadband pulsed light source applies excitation light to a fluorescent flow cell through a monochromatic excitation wavelength selector. The permeate stream passing through the flow cell is exposed to the excitation light, and the resulting emission light is detected by a spectrometer. Florescent intensity is correlated to marker concentration.

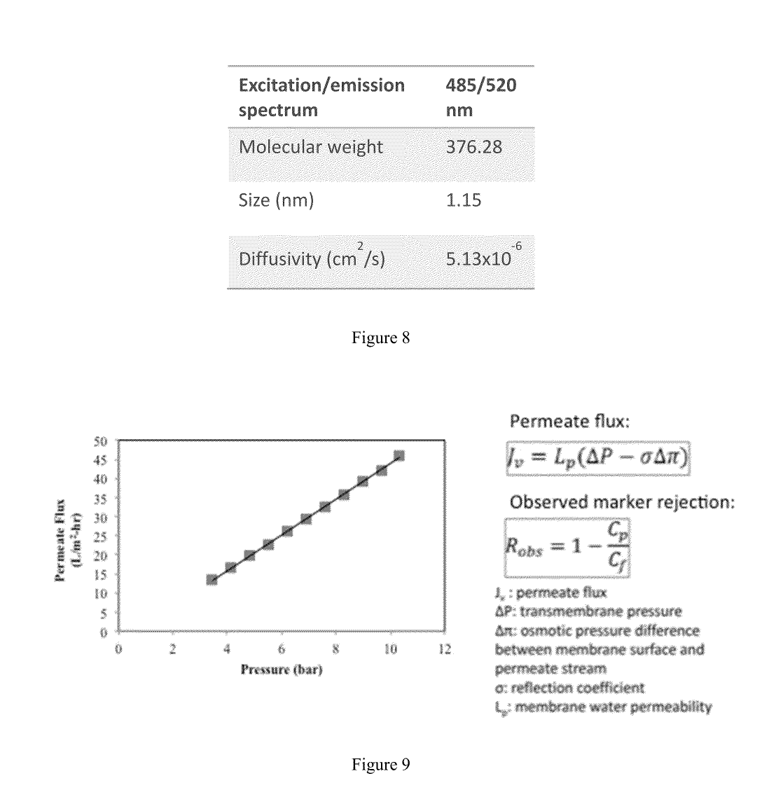

Fluorescent molecular markers are subjected to screening criteria, including low toxicity, low background fluorescence in water, economic feasibility for long term use, and commercial availability. Screening criteria are also based on experiments, including stability with light exposure, strong fluorescent intensity, stability under various pH conditions, and stability under chlorine exposure. According to these screening criteria, uranine (C₂₀H₁₂Na₂O₅) is selected for the evaluation in this example. Certain characteristics of uranine used in this example (molecular weight, size, and molecular mass diffusivity in water) are shown in FIG. 8.

FIG. 9 shows the performance of commercially available ESPA2 polyamide RO membranes (Hydranautics, Oceanside, Calif.). Specifically, FIG. 9 shows a plot of permeate flux versus transmembrane pressure for 4 RO membrane samples, subjected to a NaCl feed concentration of about 500 ppm. An average water permeability (Lₚ) is about 4.64 LMH/bar (or L/(m².hr.bar)), and an average observed salt rejection (R_{obs}) is about 97.66%.

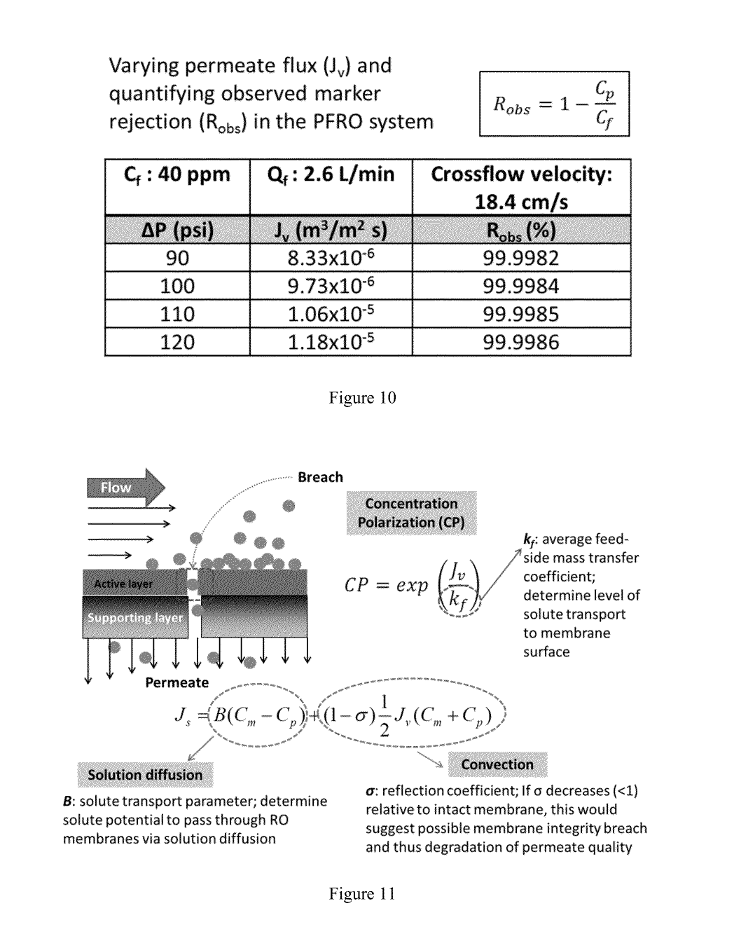

FIG. 10 shows a table setting forth results of marker rejection by intact membranes. The results demonstrate greater than 4 LRV of marker by the intact membranes. Since enteric viruses (about 20 nm to about 100 nm) are significantly larger than uranine (about 1.2 nm), these results indicate that at least 4 LRV of viruses should also be attained.

FIG. 11 shows marker transport across a membrane with a breach and associated transport parameters. The transport parameters include a solute transport parameter (B), which is indicative of a solute potential for passing through a RO membrane via solution-diffusion, an average feed-side mass transfer coefficient (k_{f}), which is indicative of a level of solute transport across a membrane/fluid concentration boundary layer, and a reflection coefficient (σ), for which a decrease relative to an intact membrane can be indicative of a membrane breach. Cₘ is a solute concentration at a membrane surface.

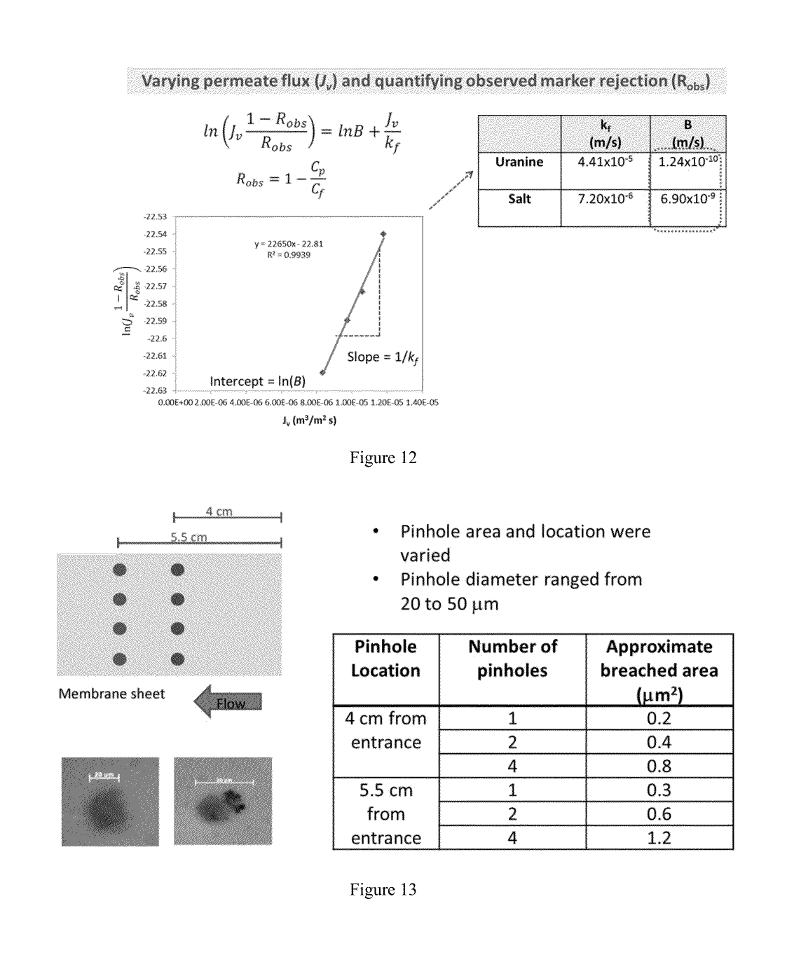

FIG. 12 shows results of marker transport characterization for intact membranes. Estimated k_{f} and B values are within expected ranges. The results indicate that uranine has a lower membrane B parameter (i.e., solute permeability), relative to NaCl, thereby increasing the sensitivity of the approach.

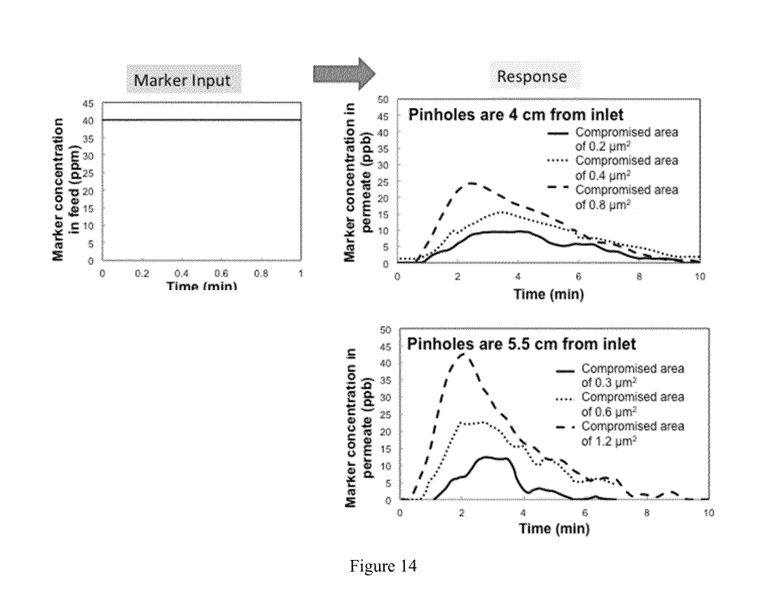

FIG. 13 shows compromised membranes with pinholes. Pinhole area and location (relative to the entrance to the membrane channel) are varied as shown in FIG. 13, with pinhole diameter ranging from about 20 μm to about 50 μm. FIG. 14 shows marker response for the compromised membranes, when subjected to a feed stream with a pulsed dosing of uranine at about 40 ppm (e.g., maximum or peak concentration). As can be observed, the permeate response is dependent upon both pinhole size and location. As such, characteristics of the permeate response curves can provide information (e.g., qualitative or quantitative information) regarding pinhole size and location.

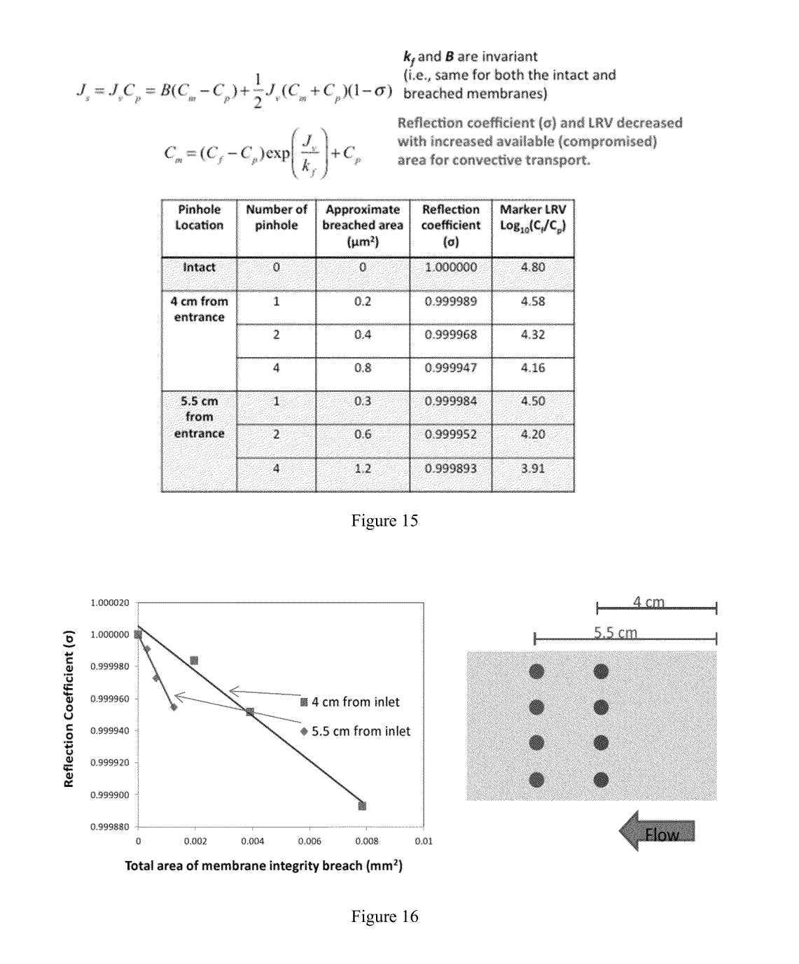

FIG. 15 shows a table setting forth values of the reflection coefficient (σ) and a LRV for the compromised membranes, when subjected to a feed stream with a pulsed dosing of uranine at about 40 ppm. As can be observed, the reflection coefficient (σ) and LRV decrease with increasing compromised area available for convective transport. In comparison, k_{f} and B values are observed to be largely invariant across intact and compromised membranes used in this example.

FIG. 16 shows plots of the reflection coefficient (σ) as a function of a total area of membrane breach and as a function of location of breach. As can be observed, the reflection coefficient (σ) correlates with both the total area of membrane breach and location of breach. Therefore, by analyzing this marker permeate response and using these correlations, the size and location of a membrane integrity breach can be determined

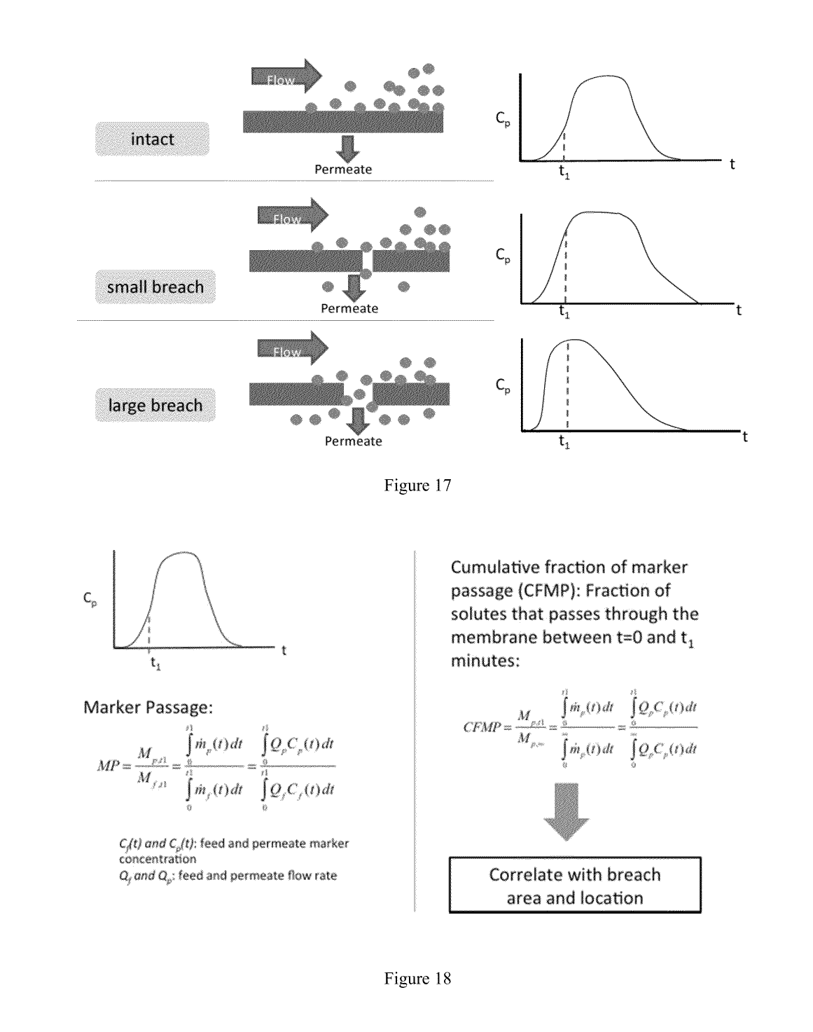

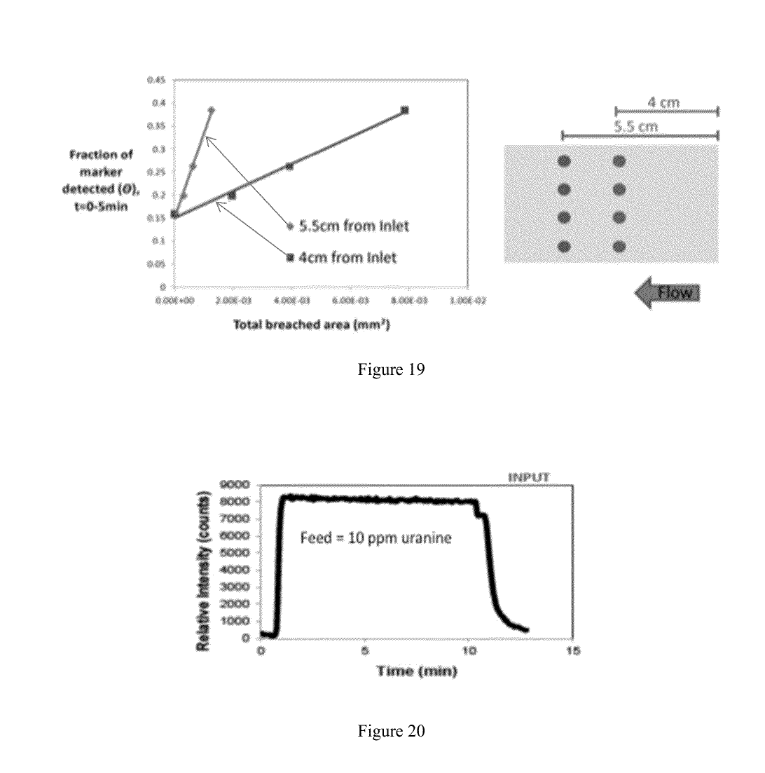

FIG. 17 shows marker transport across membranes with and without breaches and associated concentration distribution curves. The RTD (also referred to as a MPTD) can be used to quantify the fraction of a marker that passes through a membrane during a given time period (e.g., from t=0 to t=t₁), and the RTD correlates with the size and location of a breach. Specifically, a RTD function can be used to represent the concentration distribution curve of the marker (Cₚ versus t) in a normalized form as shown in FIG. 18. Using the RTD function, the fraction (θₜ₁) of the marker that passes through the membrane during the given time period (e.g., from t=0 to t=t₁) is determined, and this fraction correlates with breach size and location. This correlation is demonstrated in FIG. 19, which shows plots of the fraction (θₜ₁) as a function of a total area of membrane breach and as a function of location of breach.

### Example 2

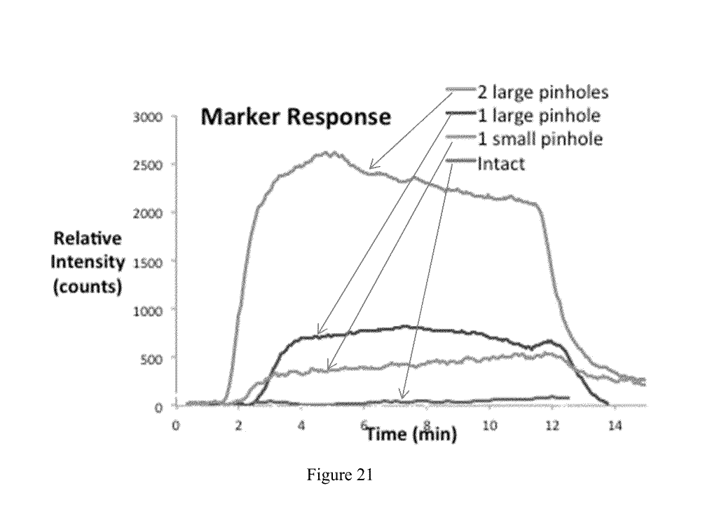

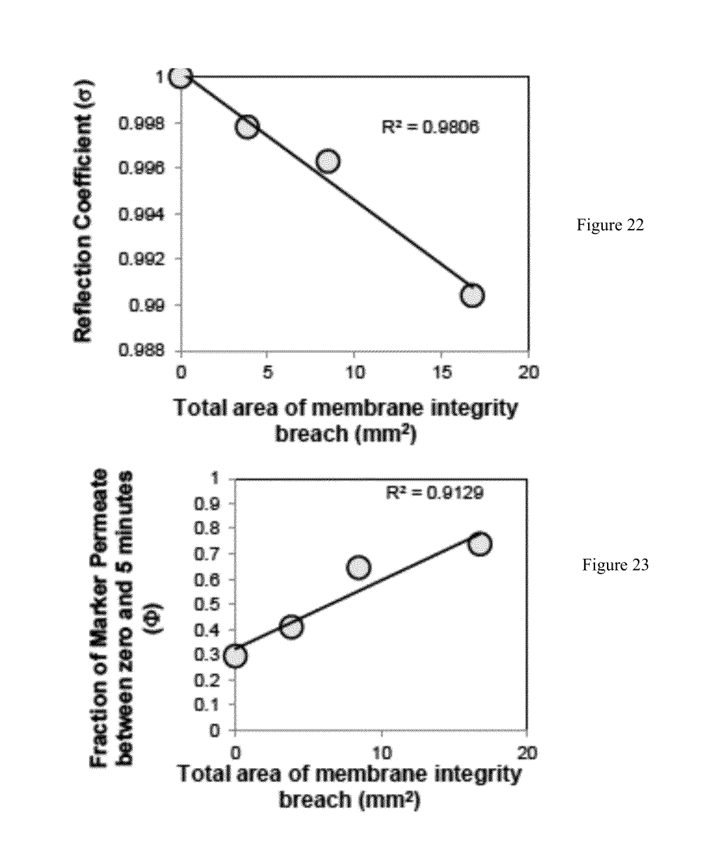

In this example, a fluorescent molecular marker (uranine), which allows detection at a concentration as low as about 0.2 ppm, is selected for monitoring of membrane integrity. Pinhole membrane breaches (with a diameter of about 70-100 μm) are created using a needle. Subsequently, uranine is injected into feed water to achieve a step input of about 10 ppm (see FIG. 20) to achieve a dosing at this concentration for a period of about 10 minutes, and a concentration of uranine (as represented by its fluorescence intensity) in the permeate is quantified. It is observed that the fluorescent intensity in the permeate increases with increasing breach size (see FIG. 21). In addition, there is a correlation between the reflection coefficient (σ), the MPTD, and the breach size (see FIG. 22 and FIG. 23). Accordingly, this example demonstrates that the molecular marker approach can be used as a basis for reliable RO membrane integrity detection and characterization to comply with water regulatory specifications.

### Example 3

This example demonstrates a framework for the estimation of RO membrane breach size and virus rejection in both a plate-and-frame and spiral-wound RO systems. Specifically, the presence and extent of breach are identified, and virus passage potential is then evaluated. The framework can be extended to other pathogens and impurities.

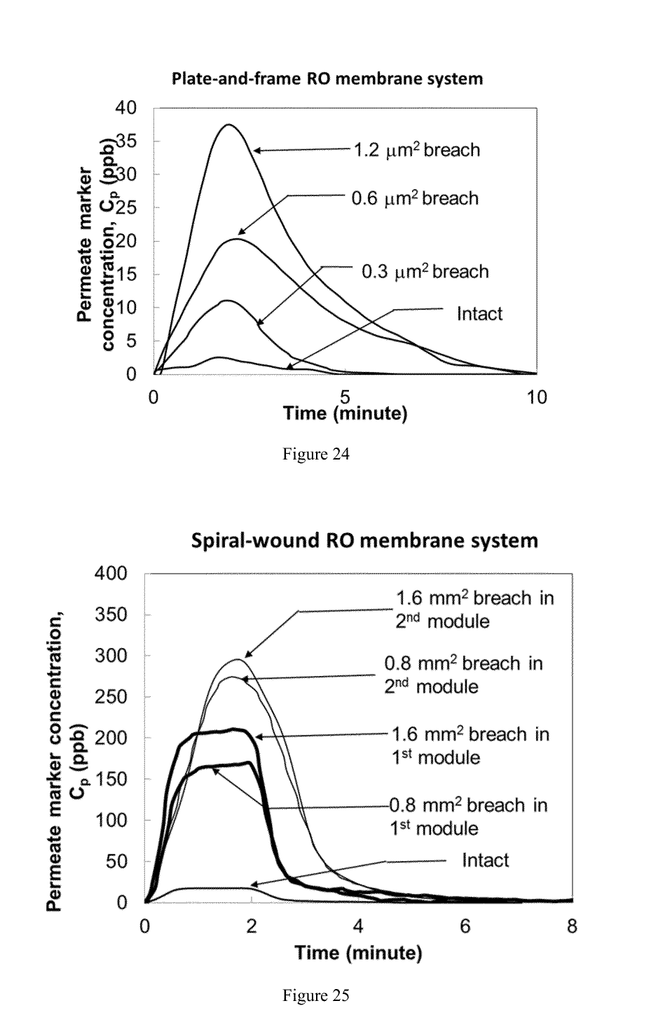

FIG. 24 shows a permeate concentration of a fluorescent molecular marker (as represented by its fluorescence intensity), in response to a pulsed marker injection to the RO feed, as a function of time for intact and compromised membranes in a plate-and-frame RO membrane system, and FIG. 25 shows a permeate concentration of the fluorescent molecular marker (as represented by its fluorescence intensity) as a function of time for intact and compromised membranes in a spiral-wound RO membrane system. As can be observed, the permeate marker response is dependent upon the presence and number of pinholes. With such data, the presence of membrane breach can be identified, and the extent of membrane breach can be estimated through RTD analysis. Based on the extent of membrane breach (e.g., breach size or area), the degree of passage of pathogens through the breach can be estimated.

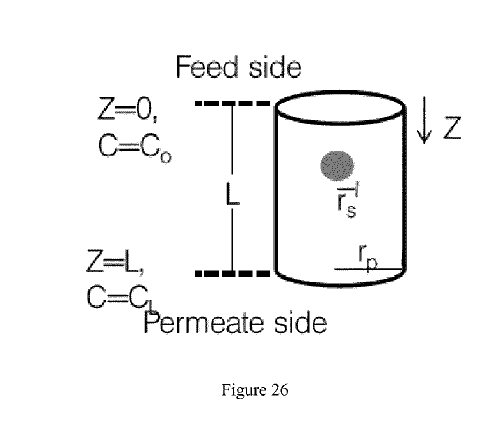

In this example, a cylindrical pore model is used as shown in FIG. 26, although the framework can be extended to other pore models. Marker rejection data and parameters (e.g., a marker concentration in the pore, Cₚₒᵣₑ, permeate marker concentration (Cₚ), a marker concentration at a membrane surface (Cₘ), and a marker rejection (Rₘₐᵣₖₑᵣ)) are determined, and then used to determine a ratio of a marker size to a breach size according to the following equation:

$${R}_{marker } = 1 - \frac{{C}_{pore}}{{C}_{m}} = 1 - \frac{φ {K}_{c}}{1 - exp ( - Pe ) ( 1 - φ {K}_{c} )} \qquad ( 3 )$$

where φ is the ratio of the average solute concentration in the pore to the solute concentration at the membrane surface, K_{c} is the hydrodynamic coefficient given by Eqn. 8, and Pe is the solute Peclet number (Eqn. 10). Eqn. 3 is used to estimate the breach size (using the calculated value of given the marker rejection as determined for the specific operating conditions and marker dose rate.

Given the breach size as determined based on the analysis of Eqn. 3, the ratio of virus to breach size is calculated (i.e., for the virus) and the virus rejection can be estimated by inserting the new for the virus in the equation below:

$${R}_{viruses} = 1 - \frac{Φ {K}_{c}}{1 - exp ( - Pe ) ( 1 - Φ {K}_{c} )} \qquad ( 4 )$$

where φ, K_{c}, and Pe are specific for the virus size.

The following sets forth further details of the framework. A solute flux, Jₛ, can be represented as:

$${J}_{s} = - KD \frac{d {C}_{z}}{d z} + {GVC}_{z} \qquad ( 5 )$$

where K and G are lag parameters (accounting for the pore walls and geometry) for diffusion and convection, respectively, due to the presence of pore walls, V is the fluid velocity at a given radial position, C_{z} is the marker concentration at a given radial position, and z is the position perpendicular to the membrane

Assuming spherical solute particles, an average flux over a pore cross section can be represented as:

$$〈 {J}_{s} 〉 = \frac{{\int }_{0}^{1} {J}_{s} β d β}{{\int }_{0}^{1} β d β} = 2 {\int }_{0}^{1 - λ} {J}_{s} β d β \vert β = \frac{r}{{r}_{p}} λ = \frac{{r}_{s}}{{r}_{p}} \\ 〈 {J}_{s} 〉 = - 2 D {\int }_{0}^{1 - λ} K \frac{d C}{d z} β d β + 2 {\int }_{0}^{1 - λ} GVC β d β \qquad ( 6 )$$

in which rₚ and rₛ are the pore and solute radii, respectively, and <Js> is the average solute flux and r is radial position within the pore.

Also, a flow velocity profile and a concentration profile within the pore can be represented as:

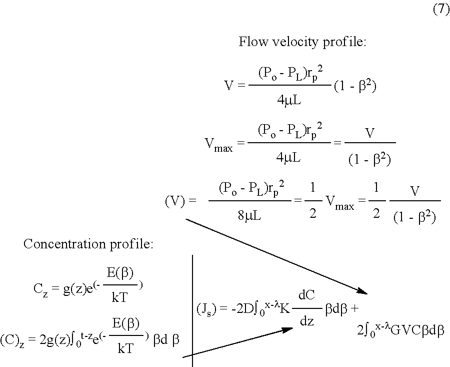

In which V is the fluid velocity in the pore at radial position r, <V> is the average solution velocity in the pore, Pₒ and P_{L} are the pressures at the opening (feed-side) and downstream end of the pore, respectively, μ is the solution viscosity, L is the pore length, D is the solute diffusivity, and g(z) and E(β) are functions of axial position (i.e., z) and of radial position, the latter being related to the electrostatic force between the solute and the pore wall, respectively.

Next, an average solute flux and the solute distribution coefficient φ, specified as the ratio of the average solute concentration in the pore to the solute concentration at the membrane surface, can be represented as:

$$\begin{matrix} Average solute flux \text{:} \\ 〈 {J}_{s} 〉 = - {K}_{d} D \frac{d {〈 C 〉}_{z}}{d z} + {K}_{c} 〈 V 〉 {〈 C 〉}_{z} \\ {K}_{d} = \frac{{\int }_{0}^{1 - λ} Ke ( - \frac{E ( β )}{kT} ) β d β}{{\int }_{0}^{1 - λ} {e}^{( - \frac{E ( β )}{kT} )} β d β} \\ {K}_{c} = \frac{{\int }_{0}^{1 - λ} G ( 1 - {β}^{2} ) {e}^{( - \frac{E ( β )}{kT} )} β d β}{{\int }_{0}^{1 - λ} {e}^{( - \frac{E ( β )}{kT} )} β d β} & ( 8 ) \\ Distribution coefficient \text{:} \\ Φ = \frac{{〈 C 〉}_{z}}{{C}_{z}} = 2 {\int }_{0}^{1 - λ} {e}^{( - \frac{E ( β )}{kT} )} β d β \vert \begin{matrix}At z = 0 and at z = L , E = 0 \\ Φ = {( 1 = λ )}^{2} \\ {〈 C 〉}_{L} = Φ {C}_{L} \\ {〈 C 〉}_{o} = Φ {C}_{o}\end{matrix} & ( 9 )\end{matrix}$$

in which C_{z} and <C_{z}> are the solute concentration and the average solute concentration, respectively, Cₒ and C_{L} are the solute concentrations at the pore, with <Cₒ> and <C_{L}> being the solute concentration on the feed side and the permeate sides of the membrane, and K_{d} is the lag parameter for diffusion.

Also, a flux equation and a marker rejection can also be represented as:

$$Derive flux equation \text{:} \\ 〈 {J}_{s} 〉 = - {K}_{d} D \frac{d {〈 C 〉}_{z}}{d z} + {K}_{c} 〈 V 〉 {〈 C 〉}_{z} \\ \\ 〈 {J}_{s} 〉 = \frac{Φ {K}_{c} 〈 V 〉 {C}_{o} ( 1 - \frac{{C}_{L}}{{C}_{o}} exp ( - Pe ) )}{1 - exp ( - Pe )} \\ {SP}_{pore} = \frac{{C}_{pore}}{{C}_{o}} = \frac{〈 {J}_{s} 〉 \text{/} 〈 v 〉}{{C}_{o}} = \frac{Φ {K}_{c}}{1 - exp ( - Pe ) ( 1 - Φ {K}_{c} )} \\ {R}_{marker} = 1 - \frac{{C}_{pore}}{{C}_{m}} = 1 - \frac{Φ {K}_{c}}{1 - exp ( - Pe ) ( 1 - Φ {K}_{c} )} \\ Pe = \frac{{K}_{c} 〈 V 〉 L}{{K}_{d} D} \qquad ( 10 )$$

where φ, K_{c}, and Pe are functions of, and:

$$\begin{matrix}{C}_{m} = ( {C}_{j} - {C}_{p} ) exp ( \frac{{J}_{v}}{{k}_{m}} ) + {C}_{p} & ( 11 ) \\ 〈 V 〉 = \frac{( {P}_{o} - {P}_{L} ) {r}_{p}^{2}}{8 μ L} & \\ {I}_{s , pore} = \frac{{A}_{total} {J}_{v} {C}_{p , total} - ( {A}_{total} - {A}_{pore} ) B ( {C}_{m} - {C}_{p , total} )}{{A}_{pore}} & ( 12 ) \\ {C}_{pore} = \frac{{J}_{s , pore}}{{V}_{pore}} & \end{matrix}$$

in which Aₜₒₜₐₗ and Aₚₒᵣₑ are the equivalent areas of the membrane surface and the breach, respectively, B is the solute transport parameter for the intact membrane areas, C_{p,total} is the solute permeate concentration, Cₘ is the solute concentration at the membrane surface, J_{s,pore} is the solute flux through the pore, Vₚₒᵣₑ is the flow velocity through the pore and SPₚₒᵣₑ is the solute passage ratio being specified as the of the average solute concentration in the pore to that at the membrane surface.

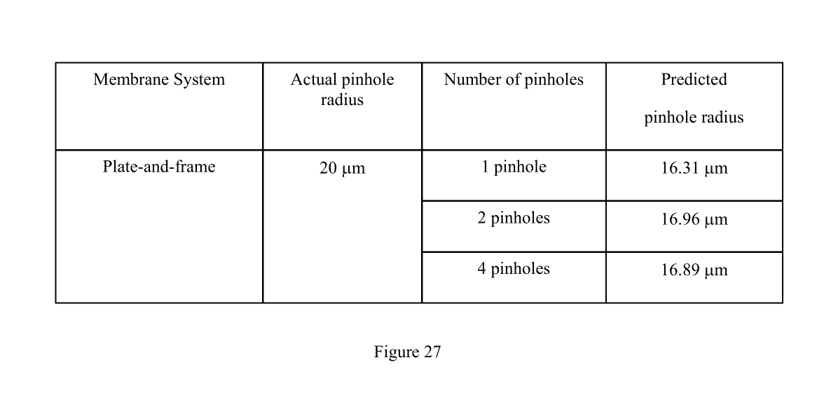

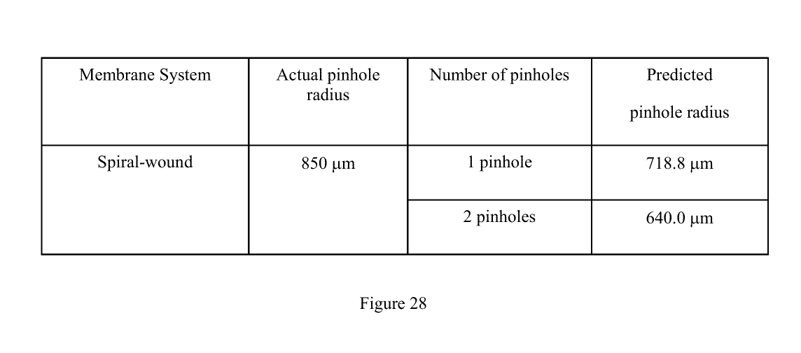

Using the above equations, breach sizes are estimated from marker responses and compared to actual breach sizes. Results are set forth in FIG. 27 for a plate-and-frame RO membrane system (marker feed dosing concentration of C_{f}=40 mg/L) and FIG. 28 for a spiral-wound RO membrane system (marker feed dosing concentration of C_{f}=20 mg/L). In the estimation of breach sizes, the presence of a corresponding single pinhole was assumed for all cases. As can be observed, the estimated breach sizes generally compare well with the actual breach sizes, although somewhat greater deviation is observed for the case of multiple pinholes in the spiral-wound membrane of this example.

### Example 4

Disinfectants, such as Cl₂, NaOCl, chlorine dioxide, or chloroamines, are often used as disinfectants and at times to mitigate against biofouling on RO membrane surfaces. However, RO membranes, such as polyamide (PA) RO membranes, are prone to chemical oxidation when exposed to such disinfectants. For example, RO membranes that are exposed to NaOCl can undergo oxidation of the active PA layer of the RO membrane, resulting in increased membrane surface roughness and surface hydrophilicity. Also, a loss of membrane integrity due to chemical oxidation can lead to increased solute passage across the membrane.

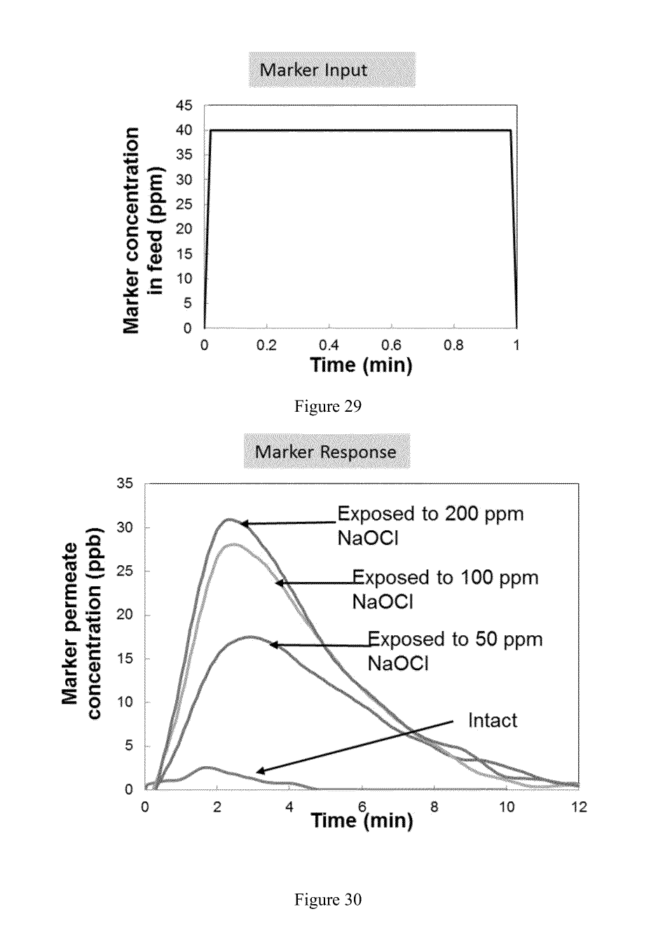

In this example, the passage of a fluorescent molecular marker (uranine) across the RO membrane in a plate-and-frame RO system is monitored by a spectrofluorometer system in real-time, with the RO system operated in a single-pass mode with tap water. Uranine is injected into feed water to achieve a step input of about 40 ppm (see FIG. 29) for about 1 minute pulse duration, and a concentration of uranine in the permeate is quantified as a function of time for an intact membrane and membranes exposed to different concentrations of NaOCl (see FIG. 30). It is observed that there is an increase in marker permeate concentration for the membranes exposed to NaOCl, relative to the intact membrane, indicating a loss of membrane integrity as a result of exposure to NaOCl. It is also observed that the marker permeate response is dependent upon, or correlates with, NaOCl concentration.

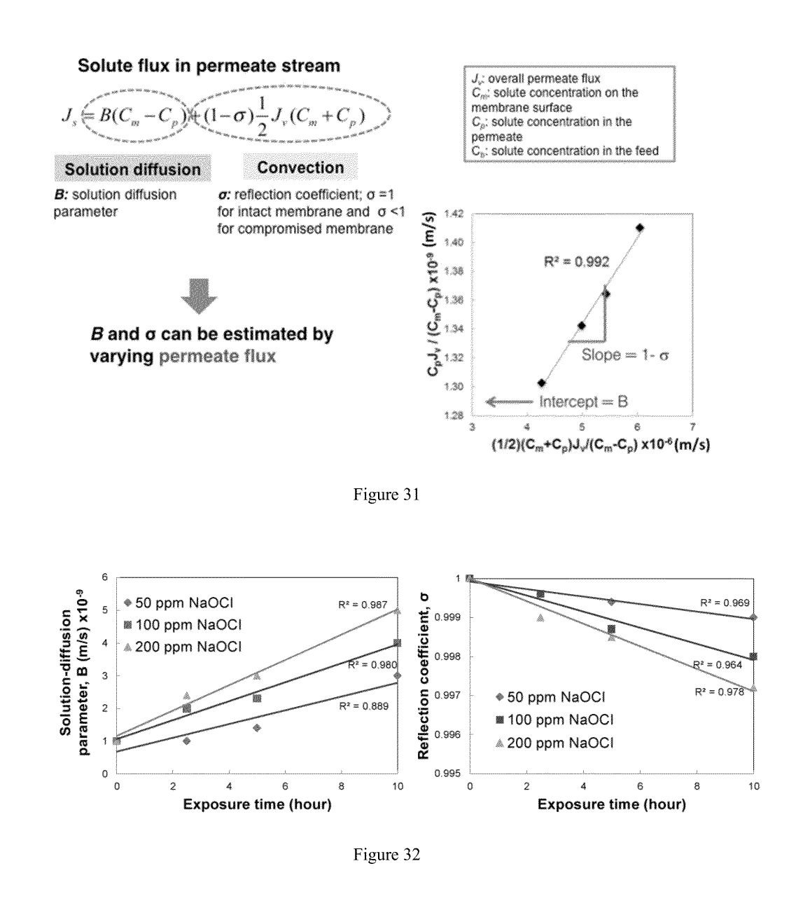

Marker transport across a membrane can be represented by a solute flux Jₛ in a permeate stream, which is a function of a solute concentration on a membrane surface Cₘ, a solute concentration in the permeate stream Cₚ, an overall permeate flux Jᵥ, and transport parameters that include a solution diffusion parameter B and a reflection coefficient σ. B and σ can be estimated by varying the permeate flux Jᵥ, according to the equation below and as shown in FIG. 31.

$$\frac{{J}_{v} {C}_{p}}{{C}_{m} - {C}_{p}} = B + ( 1 - σ ) \frac{1}{2} {J}_{v} ( \frac{{C}_{m} + {C}_{p}}{{C}_{m} - {C}_{p}} ) \qquad ( 13 )$$

FIG. 32 shows estimated values of the solution diffusion parameter B and the reflection coefficient σ for membranes exposed to different concentrations of NaOCl. As can be observed, there is an increase in both the contributions of solution-diffusion (i.e., the B solute transport parameter) and convection (indicated by decrease in the reflection coefficient) of solute (marker) transport across the membranes. Both B and σ are observed to change more rapidly as a function of exposure time at higher chlorine concentration.

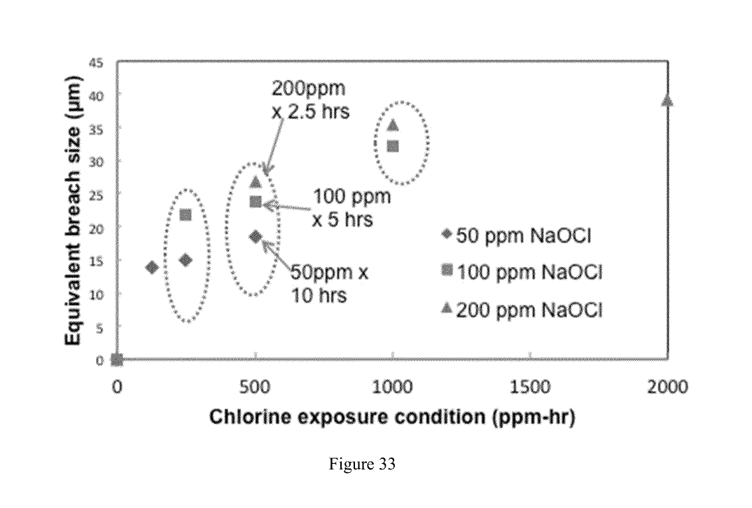

Using the framework set forth in Example 3, an effective breach size can be estimated as a quantitative measure of the extent of membrane integrity loss as if there is a membrane breach (pinhole). FIG. 33 shows effective breach sizes estimated for membranes exposed to different concentrations of NaOCl and for different exposure times. It is observed that the extent of membrane integrity loss increases with increasing NaOCl concentration and exposure time, with concentration having a more pronounced impact on membrane integrity than exposure time. Thus, this example demonstrates that the pulsed marker method can be used to detect membrane integrity loss caused by chemical oxidation, as well as estimating the extent of the membrane integrity loss. This example also shows that, while the level of membrane integrity loss (as quantified by the effective breach size) correlates with the typical used metric of oxidant ppm-hr metric (i.e., exposure concentration times the exposure period), however, at the same ppm-hr, a higher oxidant exposure concentration results in a greater level of membrane integrity loss.

### Example 5

In this example, an automated PM-MIMo approach is established by parameterizing marker response data via a marker permeation time distribution (MPTD) analysis. In this approach, the fraction of the total marker passage (FTMP), θₜ₁, through a membrane during a given time period (e.g., from t=0 to t₁) is given as:

$${Θ}_{t 1} = \frac{{\int }_{0}^{t 1} {Q}_{p} {C}_{p} ( t ) d t}{{\int }_{0}^{∞} {Q}_{p} {C}_{p} ( t ) d t} \qquad ( 14 )$$

in which Qₚ is a permeate flow rate, and Cₚ(t) is a marker concentration in the permeate stream at time t. It is noted that the denominator of the above equation represents the total mass of permeate that has passed through the membrane. For a substantially constant permeate flow, the above equation can be written as:

$${Θ}_{t 1} = {\int }_{0}^{t 1} E ( t ) d t \qquad ( 15 )$$

where the MPTD function, E(t), is given as:

$$E ( t ) = \frac{{C}_{p} ( t )}{{\int }_{0}^{∞} {C}_{p} ( t ) d t} \qquad ( 16 )$$

It is expected that E(t) and θₜ₁ would depend on a membrane breach size and location, both of which can affect the degree of marker transport across the membrane. Another measure of marker feed passage (MFP) can be quantified as the fraction of the cumulative marker mass injected into the RO feed that passes across the membrane at a given time t₁:

$$MFP = \frac{{Q}_{p} {\int }_{0}^{{t}_{1}} {C}_{p} ( t ) d t}{{Q}_{f} {\int }_{0}^{{t}_{1}} {C}_{f} ( t ) d t} \qquad ( 17 )$$

It is noted that when t₁ in the denominator of the above equation is set to infinity, the MFP is the fraction of the total injected marker feed mass that has passed across the membrane up to time t₁.

The marker rejection by the membrane (intact or compromised) can also be determined from the marker pulse response. It can be shown that, for substantially constant volumetric feed and permeate flow rates, the observed rejection for the marker is given by:

$$Robs = 1 - \frac{{\int }_{0}^{∞} {Q}_{p} {C}_{p} ( t ) d t}{{\int }_{0}^{τ} {Q}_{f} {C}_{f} ( t ) d t} \qquad ( 18 )$$

in which Q_{f} and C_{f} are the feed volumetric flow rate and marker concentration, respectively, and t is the pulse feed injection period or duration. Due to solute dispersion (in both the feed channel and sampling lines), and residence time of the permeate sampling location to the detector, and the permeate concentration decline, post cessation of the pulse injection continues to a vanishing value in a period of time that is typically longer (up to a factor of 20 or higher in some cases) than the length of the injection period.

Correlation of Marker Passage Fraction with Membrane Breach Characteristics:

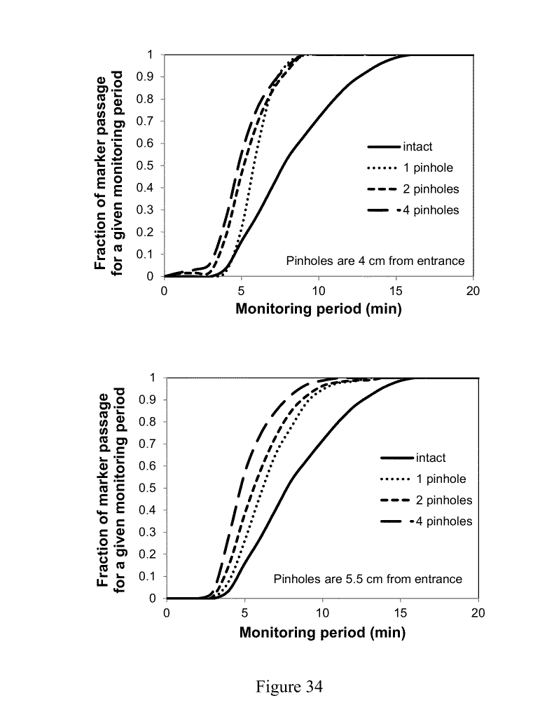

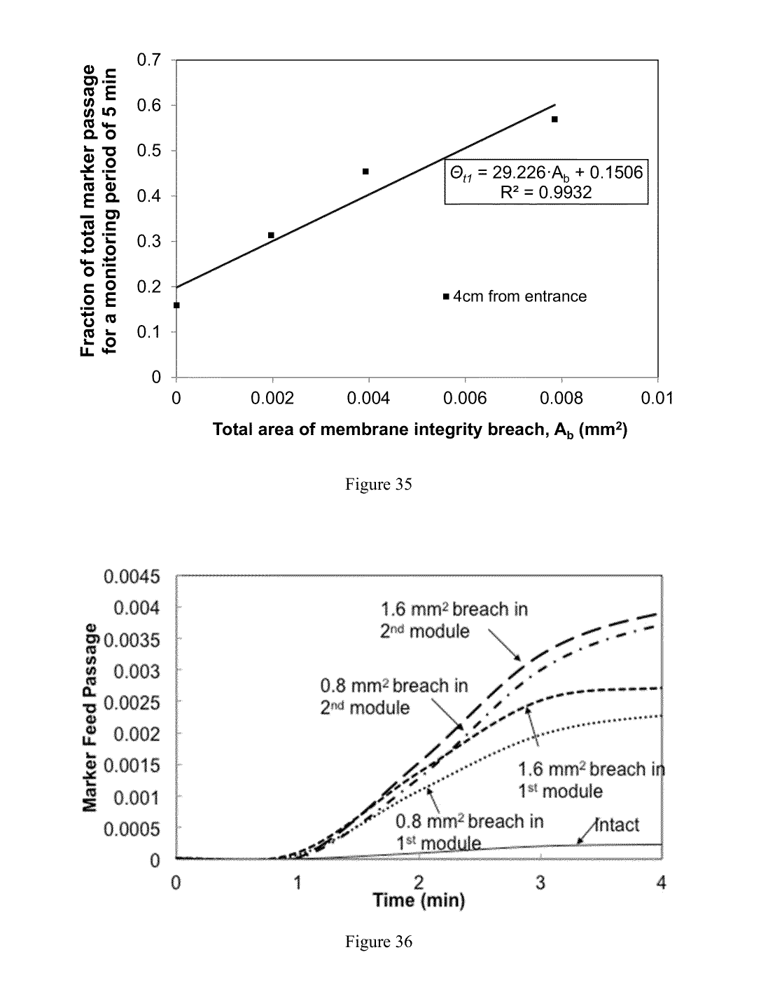

The MPTD approach can be utilized to assess the integrity of the membranes and thus is suitable for assessing both intact membranes and those that have suffered integrity loss. An example of the FTMP, the resulting permeate fluorescence response is shown in FIG. 34. At a given monitoring period, and for the same axial position along the membrane channel, a higher FTMP is observed as the breach areas increase. When the breach is located further away from the RO feed channel entrance (FIG. 34 (bottom)), a similar qualitative FMTP behavior is observed with respect to both the relative breach size and monitoring time. The FMTP can be correlated with the breach size, at a given monitoring time, as shown in FIG. 35. Such an approach is useful for assessing breach severity, for a given membrane plant, by comparing FMTP response with a library of FMTP reference traces obtained for different size breaches (and locations) for the given membrane plant.

The occurrence of a breach is readily detectable using the current approach by comparing the FTMP profiles of intact and membranes with integrity loss. It is observed that the FTMP increases more rapidly for breaches that are near the RO feed channel entrance. Interpretation of this behavior, however, can be complicated owing to the coupling of diffusive and convective transport across the membrane. For example, in spiral-wound elements, where breach locations can be set at greater distances apart, more distinct differences in the FTMP profile should be expected. In a large RO plant with multiple pressure vessels in series or parallel, it may be desirable to monitor the marker in the permeate stream at different locations throughout the RO plant in order to assess both breach location and severity.

Marker Injection and Response in the Spiral-wound RO (SPRO) Membrane System:

The PM-MIMo approach was evaluated for detection of membrane integrity breach in a spiral-wound RO (SPRO) membrane system with two XLE-254 elements in series. Single-pass RO desalinating runs were carried out (using microfiltered tap water) at a cross-flow velocity of about 12.12 cm/s and transmembrane pressure of about 160 psi. Once steady-state RO operation was attained, uranine solution was injected in the SPRO feed stream, over a period of about two minutes, to achieve about 20 ppm uranine concentration in the SPRO feed stream. Marker permeate concentration-time monitoring data were then obtained for different membrane integrity breaches (as in FIG. 25).

As shown in FIG. 25, the marker concentration-time response profiles show that the marker response varies with the severity and location of the membrane integrity breach. The marker peak intensity for the breached membrane increased to a significant degree relative to the intact membrane, consistent with the expectation of greater marker passage through the breach. A larger breach (e.g., two pinholes versus one pinhole) resulted in higher peak intensity. Moreover, when the breach was in the second (e.g., tail) element, the marker peak concentration was higher and with apparently greater area under the concentration-time curve (indicating increased total marker mass passage). This latter observation may be attributed, in part, to the impact of concentration polarization which is typically marginal in short plate-and-frame RO membrane channels but more significant for longer commercial spiral-wound RO membrane elements.

Marker Permeation Time Distribution (MPTD) for the SPRO System:

Evaluation of the PM-MIMo approach in the SPRO system revealed that by examining the marker concentration-time profile, in response to a marker pulse input, one can ascertain the presence of a membrane integrity breach (FIG. 34) and its severity (FIG. 35). The marker concentration-time profiles can be analyzed using both the MFP and FTMP (e.g., θₜ₁) as presented by the above equations.

The MFP profiles in FIG. 36 show that the loss of membrane integrity is readily discernible relative to the intact membrane elements. A larger breach (e.g., 2 pinholes versus one), at a given location (e.g., lead or tail element), results in the MFP that increases as the plateau region of the MFP profiles is approached. Also, the MFP (also toward the plateau region) is higher for a breach in the tail element. It should be recognized that the MFP response is governed by both breach size and location as well as increased marker concentration with increased recovery along with decreased flux in the flow direction (e.g., as one progresses from the lead to the tail elements). The above indicates that monitoring of different plant segments would serve to identify the general location (e.g., with respect to the tail or lead elements) of the membrane breaches. The MFP profiles also reveal loss of membrane performance when a membrane is exposed to an oxidant such as chlorine in the present example.

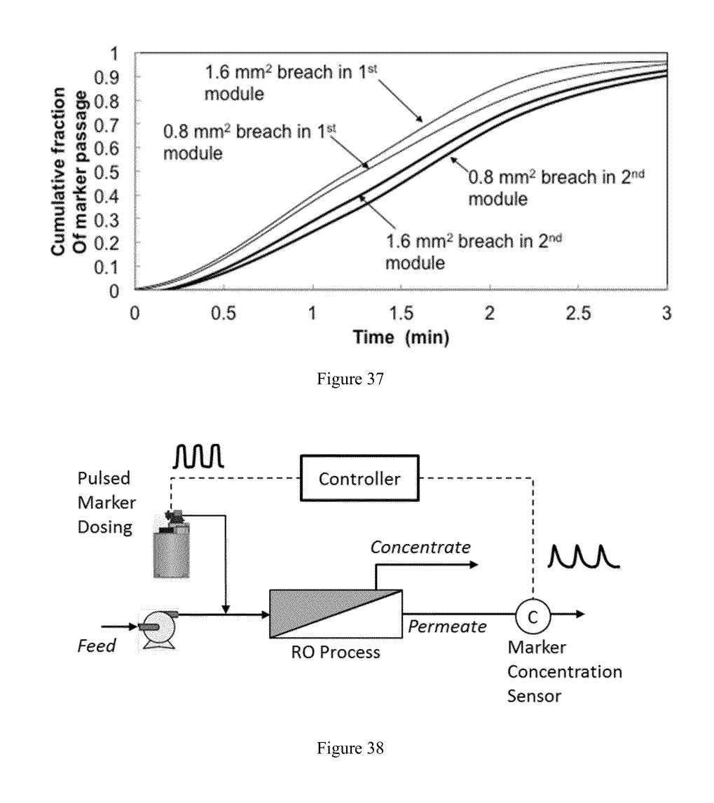

Monitoring for loss of integrity via the FTMP-time profile (e.g., the time dependence of the fraction of total marker passage) is shown in FIG. 37 for both intact and compromised membranes. The results of this analysis demonstrate that marker detection in the permeate occurs earlier when the breach is in the lead element. The FMTP-time profiles are also displaced forward in time, and the FMTP is generally lower (over the bulk of the monitoring period), for the same breach location, when the breach area is smaller (e.g., one pinhole versus two). The FMTP-time profiles for the membranes that were exposed to chlorine indicates markedly earlier marker detection relative to the membranes with pinholes. The above behavior can be understood by noting that the exposure of the membrane to chlorine was over the entire membrane surface, and therefore membrane integrity loss was not confined to a localized area as in the case of the membranes with mechanically induced pinholes. As a result it should be expected that marker passage in the chlorine-exposed membranes could take place throughout the membrane element train (i.e., lead as well other membranes leading to the tail elements). It is also important to note that when small breaches are present in a localized area (e.g., such as a pinhole in a specific location), little impact would be detected on the measured total permeate flow or even salt passage. In contrast, the FMTP response is significantly impacted by breach location and severity. For example, for the breached lead element, the bulk of marker passage is primarily in this element for which the permeate flux is higher than for the second element. Consequently, the FMTP for the second breached element should be expected to be lower than for the first breached element. While the FMTP provides sensitivity regarding breach severity, greater sensitivity of breach detection with respect to location is provided by comparing the MFP-time profiles (see FIG. 36).

### Example 6

Overview:

The operation of a marker-based method, involving a pulsed dosing of a fluorescent molecular marker into the feed stream of a RO membrane system coupled with real-time monitoring of marker concentration in the permeate stream, was investigated for a systematic detection and characterization of RO membrane integrity breaches (defects). The impact of mechanical membrane breaches (as small as about 20 μm in diameter) on the marker permeate response was evaluated in a plate-and-frame RO (PFRO) system, with a specially designed in-line fluorescent marker detection system. Peak concentration in the marker permeate response increased with breached area as a result of increased convective marker transport through the membrane's breached area. Marker LRV as quantified from the marker permeate response indicated that the current method can demonstrate greater than about 4 LRV for marker for an intact RO membrane, and thus provide sufficient sensitivity for regulations. Testing of this approach in a pilot-scale spiral-wound RO (SPRO) system with membrane breaches (mechanically induced damage) of various sizes and at various axial locations indicated that the extent and location of a membrane breach can be correlated to the characteristics of the marker permeate response via a marker permeation time distribution (MPTD) framework.

Introduction:

The use of HPM processes, particularly RO, has grown significantly over the past few decades in addressing ground water decontamination and municipal water reuse applications to safeguard water supplies against harmful pathogens and impurities. In principle, RO is effective in rejecting materials as small as monovalent ions, and thus RO membranes should provide high removal of pathogens (e.g., protozoa, bacteria, and enteric viruses). However, the presence of membrane and membrane module integrity breaches (defects) may render RO processes ineffective for pathogen removal. Membrane integrity breaches may occur due to various factors including manufacturing defects in the membranes or membrane modules, insufficient or improper pretreatment or pre-filtration, chemical attacks (e.g., oxidation), faulty installation and maintenance, failure of module assembly components (e.g., O-rings), and stress and strain on membranes from operating conditions (e.g., water hammer, passage of sharp debris, and cleaning of fouled/scaled membranes). In the presence of membrane breaches (even as small as about 20-30 nm in diameter), harmful pathogens can pass to the product permeate stream and pose a potential health threat, which is of particular concern in potable water production. The USEPA's SWTR and GWR specify that membrane processes should implement effective real-time membrane integrity monitoring to ensure robust system control and operation that will ensure public protection. Membrane treatment processes should demonstrate log removal (LRV=log(C_{f}/Cₚ), where C_{f} and Cₚ are the specific solute concentrations in the RO feed and permeate streams, respectively) of 2, 3, and 4 for Cryptosporidium, Giardia cysts, and enteric viruses, respectively. Presently, virus removal credits are not given to RO processes due to the lack of reliable real-time integrity monitoring methods. Effective membrane integrity monitoring procedures are desirable for high pressure membrane processes (e.g., RO as well as nanofiltration) in order to provide assurance of sufficient public health protection and to garner public acceptance of RO processes for water reuse applications.

Indirect membrane monitoring methods, which rely on feed and permeate water quality parameters (e.g., particle counting, turbidity, conductivity, total organic carbon (TOC), and sulfate monitoring) to assess the occurrence of membrane integrity breaches, can be used to monitor integrity of LPM processes (e.g., MF and UF). However, indirect monitoring methods are typically of insufficient sensitivity for identifying the presence of breaches in RO processes. The lack of sensitivity emanates from the difficulty in accurately quantifying low levels of various monitored parameters (e.g., conductivity, TOC, turbidity, and sulfate ion concentration) typically expected in RO permeate streams. Moreover, since their accuracy depends on the target species concentration in the feed water, variability in membrane integrity monitoring metrics can often be the result of variations in RO feed water quality and permeate flux and not actually related to the occurrence of a membrane breach. In addition to indirect monitoring methods, pressure-based and marker-based approaches can be used as direct physical test methods that can be applied to membrane modules. While pressure-based methods (e.g., pressure decay or vacuum tests) can be sufficiently sensitive in detecting membrane breaches, these methods typically involve system shutdown, which can interfere with water production, lead to membrane dewatering, and can potentially result in membrane damage due to pressurization on the RO permeate side. In contrast, the use of markers for membrane integrity testing is particularly appealing since marker-based methods can be deployed in real-time and using a wide-array of possible markers to provide detection at trace levels.

The marker-based approach to membrane integrity monitoring involves marker introduction into the RO feed stream in order to examine the impact of membrane breaches on marker rejection or LRV. The use of certain markers (e.g., bacteriophage and polystyrene nanoparticles) may be prohibitive or impractical for full-scale application, given their extensive preparation procedures, lack of commercial availability, lack of methods for their recovery from water, high marker cost, potential marker toxicity to aquatic environment, and potential for membrane fouling. In contrast, the use of molecular markers allows a high detection level while reducing or minimizing the environmental, operational, and cost concerns. One possible approach to using molecular markers involves injecting a fluorescent marker (e.g., rhodamine-wt (R-wt)) of low concentration (about 1-2 ppm) at a fixed dosage rate into the RO feed stream, measuring marker concentration in the RO permeate stream in real-time or offline, and subsequently quantifying marker LRV for the membrane. However, the presence of integrity breaches in RO membranes, particularly for constant marker dose rate, can result in a marginal change (either of, or both, increase and decrease) in the LRV of R-wt at the low concentrations that would be involved from economic considerations and potentially unacceptable introduction of significant amount of marker over the long steady-state monitoring periods. It is noted that if there is significant variability in feed and permeate fluorescence signal (e.g., due to background fluorescence, light source, and temperature) during the period of (continuous) marker injection, this may adversely impact the accuracy of the marker-based approach for breach detection. Moreover, the ability to correlate marker LRV to membrane breach characteristics has not been demonstrated in previous efforts which is desirable for assessing the passage potential of pathogens into the product permeate stream. While the marker-based method has potential for sensitive and real-time monitoring of fluorescent molecular marker LRV in RO processes, a framework for the marker-based method that involves membrane breach detection and characterization has been lacking.

In this example, a pulsed injection marker-based method is introduced for real-time detection and characterization of RO membrane integrity loss. In the current approach, a relatively high concentration dose of a low-cost non-toxic molecular fluorescent marker is injected into the RO feed in a controlled pulse with marker concentration in the RO permeate monitored in real-time. The high marker pulse feed concentration (from pulse dosing) serves to avoid the complication from potential feed and permeate composition variability on the marker fluorescence signal, and elevates the marker permeate concentration to facilitate high level of detection. The sensitivity of the proposed Pulsed-Marker Membrane Integrity Monitoring (PM-MIMo) approach was initially tested using a bench-scale PFRO system. Subsequently, the impact of membrane breach severity and location on marker permeate response was examined using a pilot-scale SPRO system with breaches of various sizes in different locations along the train of membrane elements. Marker response was analyzed via fundamental models of membrane transport, as well as via evaluation of marker passage through the RO membranes to demonstrate an ability to correlate marker response to membrane breaches with respect to breach severity and location.

Experimental

Materials and Reagents:

A molecular fluorescent marker, uranine (C₂₀H₁₂Na₂O₅), which is commercially available, inexpensive, and nontoxic, was selected for the development of the pulsed marker approach. Preliminary evaluation of uranine revealed a strong uranine fluorescence signal at excitation and emission wavelengths of about 490 and about 530 nm, respectively, as well as stable fluorescence intensity at typical RO process pH operating range (e.g., pH of about 6-8) along with a high level of chlorine tolerance (e.g., at about 1-4 ppm of free chlorine). Uranine stock solutions were prepared from reagent-grade uranine powder (Fisher Scientific, Pittsburgh, Pa.) dissolved in ultra-pure deionized water from a Milli-Q water purification system (Millipore Corp., San Jose, Calif.). RO desalting runs were conducted using low salinity potable tap water (average reported total dissolved solids (TDS) of about 265 mg/l, TOC of about 1.7 mg/l, and total hardness of about 113 mg/l as CaCO₃).

RO Systems:

A PFRO system was employed along with a marker injection system and fluorescent detector or sensor (see FIG. 38) to evaluate the sensitivity of the pulsed marker approach for membrane breach detection during the preliminary testing. Briefly, the PFRO cell had flow channel dimensions of about 2.81 cm (width)×about 7.7 cm (length)×about 0.25 cm (height) with an active membrane area of about 21.6 cm². A flat-sheet polyamide ESPA2 RO membrane (Hydranautics, Oceanside, Calif.), typically used in seawater desalination and treatment of municipal wastewater effluent, was used which had an average permeability of about 4.63 LMH/bar and salt rejection of about 97.6% (for about 1,000 mg/L NaCl feed solution). Cartridge filters (about 0.2 μm pore size) (Keystone Filter, Telford, Pa.) and about 5 μm carbon filter (Pentek, Greenville, S.C.) were installed in the feed stream, prior to the marker dosing location, in order to remove suspended particulates and free chlorine from RO feed water. Water was fed to the membrane feed channel using a high pressure pump (Hydra-cell D/G-03, Wanner Engineering Inc., Minneapolis, Minn.). The desired flow rate was set by adjusting the pump variable frequency drive (VFD), bypass, and backpressure valves. Feed and permeate flow rates were monitored using digital flow meters (Flowcal 5000, Tovatech, South Orange, N.J., and S-112, Georgetown, Tex., respectively), and feed pressure was monitored with a digital gauge pressure (PGP-25B-300, Omega, Stamford, Conn.). The PFRO system was operated in a single-pass mode at a target transmembrane pressure of about 100 psi, RO feed flow rate of about 1 L/min, and a cross-flow velocity of about 18 cm/s.

The operation of the pulsed marker approach for detection and characterization of RO membrane integrity breach was evaluated using a pilot-scale SPRO desalting system. The SPRO system was loaded with two about 2.5 inch×about 40 inch spiral-wound modules housed in separate pressure vessels (rated up to about 68 bar) arranged in series. The XLE-2540 membrane modules (Dow Filmtec, Edina, Minn.), typically used for brackish water desalination, have an average permeability of about 5.14 LMH/bar and salt rejection of about 96.1% (for about 1,000 mg/L NaCl feed solution). A series of about 5 and about 0.45 μm filtration cartridges (Keystone Filter, Hatfield, Pa.) and about 5 μm carbon filter (Pentek, Greenville, S.C.) were installed in the feed stream prior to the marker dosing location. Water was fed to the RO system via a pair of positive-displacement high pressure pump (Danfoss Model CM 3559, 3 HP, 3450 RPM, Baldor Reliance Motor, Danfoss Sea Recovery, Carson, Calif.) controlled by VFDs (Model FM50, TECO Fluxmaster, Round Rock, Tex.). The desired pressure was controlled by adjusting an actuated needle valve (Model VA8V-7-0-10, ETI Systems, Carlsbad, Calif.) on the retentate stream of the SPRO pilot system. Feed and retentate pressures were monitored using two pressure transducers (0-68 bar range, Model PX409-1.0KG10V, Omega, Stamford, Conn.). The SPRO system was operated in single-pass mode at a transmembrane pressure of about 140-160 psi and cross-flow velocity of about 12 cm/s.

Fluorescence marker Detection and Injection:

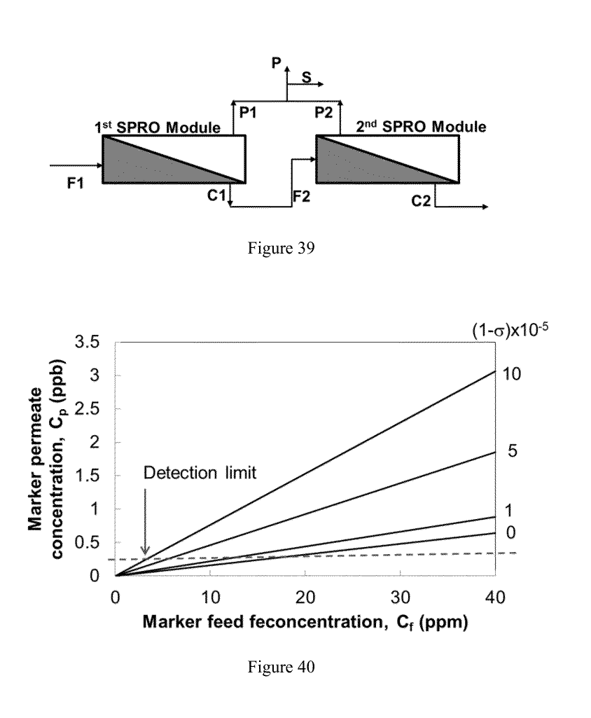

The fluorescent marker detection system included an LED light source (Ocean Optics Inc., Dunedin, Fla., LLS-490 model), a spectrometer (Maya 2000 Pro model), a fluorescence flow cell (FIA-SMA-FL-ULT model), and optical filters of 490±20 nm and 530±20 nm (OF2-GG490 and OF2-GG530) wavelengths for the excitation and emission, respectively. The RO permeate entered the spectrometer flow cell, and the emitted light intensity (at the prescribed wavelength) was acquired every about 500 ms and converted to marker concentration via a predetermined concentration-fluorescence intensity calibration. Uranine concentration detection limit with the present fluorescence detector was about 0.2 parts per billion (ppb, μg/L). It is noted that in the PFRO experiment, the total permeate flow was diverted to the spectrometer flow cell. On the other hand, in the SPRO pilot which included two elements in series, a side permeate stream was fed to the fluorescence flow cell (FIG. 39).

Prior to injection of the marker into the RO feed stream, the fluorescent background signal of the permeate stream was set once the RO system reached steady-state condition (e.g., no significant fluctuation in the permeate flux). The marker solution was injected into the feed stream in pulse mode by a metering pump (DDA 7.5-16 model, Grundfos Pumps Corporation, Bjerringbro, Denmark) with dosing flow rate of up to about 7.5 L/hr against a backpressure of up to about 16 bar. The marker injection point was located just before the high pressure pumps of the RO system in order to avoid pumping against the high pressure feed stream. The dosing flow rate, Q_{D}, of a marker feed solution of concentration, C_{D}, into a RO feed flow rate of Q_{F}, to achieve the target dosing marker concentration in the RO feed, C_{F}, can be determined based on a marker mass balance around the injection point as provided by Eq. 2. The marker injection dose profiles were set at concentrations of up to about 20-40 mg/L and a pulse duration of about 60 seconds. Marker permeate concentration was monitored as a function of time, for the duration of each marker injection event. Sufficient time was allowed, typically about 30 minutes, between individual marker runs to ensure that the fluorescence signal returned to background level.

Formation of Membrane Integrity Breaches:

Membrane integrity breaches (pinholes) were induced in both flat-sheet and spiral-wound RO membranes. For the flat-sheet membranes, the membrane coupons were lightly tapped with a tip of a needle (about 1.6-mm in diameter) to form a membrane breach or pinhole. Similarly, in the SPRO system, the SPRO membrane element was punctured (from the outer wrap through a feed spacer and a membrane sheet) with an about 16-gauge needle. The effect of pinhole size was examined by creating various pinholes in both the flat-sheet membrane coupons and on the SPRO membrane module. For the SPRO, the effect of pinhole location was assessed by creating the pinholes on either the first (lead) or second (tail) element of the SPRO system. Membrane breach sizes were determined from images obtained by a reflectance optical microscope fitted with a high resolution CCD camera.

Analysis

Establishment of the Pulsed Marker Approach:

In order to establish the concentration in the pulsed marker dose, an analysis of the expected marker permeate concentration was first carried out for the range of expected membrane transport properties. In principle, the presence of membrane breaches can be identified from an increased degree of solute convective transport across an RO membrane. In this approach, the impact of membrane breaches on marker permeate concentration can be assessed using the solution-diffusion model, where marker flux (Jₛ) through an RO membrane, which occurs via both solution-diffusion and convective transport, is given by:

Jₛ=JᵥCₚ=B(Cₘ−Cₚ)+(1−σ) C̅Jᵥ (19)

where Cₚ is the marker concentration in the feed stream, Cₘ is the marker concentration at the membrane surface, B is the marker transport parameter (i.e., mass transfer coefficient due to solution-diffusion through the membrane), σ is the reflection coefficient (an indicator of the degree of convective transport of the marker with the solvent (water) through the membrane) and C̅=(Cₚ+Cₘ)/2. For an intact RO membrane, marker transport through the membrane is controlled by solution-diffusion with negligible solute convective transport (i.e., σ→1).

In the presence of a membrane breach, coupled convective transport (in addition to solution-diffusion transport) of water and marker through the breached area is expected to increase. This level of increased convective transport is represented by a decrease in the magnitude of the reflection coefficient (σ) that can be calculated from Eqn. 19 as

$$σ = ( 1 - \frac{{C}_{p}}{\overline{C}} ) + \frac{B ( {C}_{m} - {C}_{p} )}{{J}_{v} \overline{C}} \qquad ( 20 )$$

For a given permeate flux, the reflection coefficient can be obtained using Eqn. 20 by measuring the marker permeate concentration in response to a constant marker feed dose, given the transport parameter B, and marker concentration at the membrane surface estimated from a suitable approximation of concentration polarization (CP). For the PFRO channel, CP can be estimated from the classical film model:

$$\begin{matrix}CP = \frac{{C}_{m} - {C}_{p}}{{C}_{b} - {C}_{p}} \\ = exp ( \frac{{J}_{v }}{{k}_{f}} )\end{matrix} \qquad ( 21 )$$

where C_{b} is the marker concentrations in the bulk solution and k_{f} is the marker feed-side mass transfer coefficient.

Using the above approach, both B and k_{f} can be estimated via a linear regression of experimental observed marker rejection (R_{obs}) data at varying permeate flux levels (at constant marker feed dose) using the following relationship (i.e., deduced from Eqs. 19 and 21):

$$ln ( {J}_{v} \frac{1 - {R}_{obs}}{{R}_{obs}} ) = ln B + \frac{{J}_{v}}{{k}_{f}} \qquad ( 22 )$$

For the SPRO system in this example, the average CP (CP_{avg}) for a given 2.5 inch×40 inch spiral-wound XLE-2540 elements was estimated from

$${CP}_{avg} = ( \frac{{C}_{m} - {C}_{p}}{{C}_{b} - {C}_{p}} ) = {k}_{p} exp ( \frac{2 Y}{2 - Y} ) \qquad ( 23 )$$

where kₚ is the element-specific parameter (about 0.98 for the present elements), and Y is the water recovery. It is noted that k_{f}, B, and Cₘ may be reasonably assumed to hold for both the intact membrane and for a membrane with a small breach (e.g., micron size) as was the case in the present example. Note that expressions alternative to Eqn. 23 for estimating the degree of concentration polarization in specific locations in the RO plant may be applicable to different RO element types and configurations.

Eq. 23 indicates that, for a given permeate flux, the reflection coefficient can be obtained by measuring the marker permeate concentration in response to a constant marker feed dose, and quantifying the marker concentration at the membrane surface (as determined for the specific marker feed dose). As an illustration, the impact of the reflection coefficient on marker permeate concentration for the PFRO system is shown in FIG. 40, generated using Eqs. 20-22 and the experimentally determined k_{f} and B. It is noted that the marker permeate concentration would increase with a decrease in the reflection coefficient (FIG. 40), and even a small decrease in σ (e.g., as small as about 10⁻⁵-10⁻⁴) could result in a significant (e.g., as high as about 82%) increase in Cₚ. Accordingly, the presence of a membrane breach, in principle, can be identified by measuring an increase in the marker permeate concentration for the membrane with a breach (or defect), relative to that of the intact membrane. In addition, since Cₚ also increases with C_{f} (FIG. 40), marker permeate response can be raised above the instrument detection limit by using a higher marker feed concentration. As a result, in order to achieve a marker permeate concentration of higher than the instrument detection limit (about 0.2 ppb) for the set of membranes of this example, the marker feed concentration (C_{f}) was set in the range of about 20-40 ppm.

Marker Log Removal (LRV):

Marker passage through an intact RO membrane is primarily due to solution-diffusion. However, passage through a breached membrane (or compromised element) is by both solution-diffusion and convection. Therefore, in order to quantify the contributions of diffusive versus convective transport to marker passage across the membrane to the overall marker LRV (LRVₒᵥₑᵣₐₗₗ), it is instructive to evaluate the contributions of diffusive (LRV_{diff}) and convective transport (LRV_{conv}) to LRVₒᵥₑᵣₐₗₗ that are specified as

$$\begin{matrix}\begin{matrix}{LRV}_{overall} = log ( \frac{{C}_{f}}{{C}_{p}} ) \\ = log ( \frac{1}{1 - {R}_{obs}} )\end{matrix} & ( 24 a ) \\ {LRV}_{diff} = log ( \frac{{C}_{f}}{{C}_{p , diff}} ) & ( 24 b ) \\ {LRV}_{conv} = log ( \frac{{C}_{f}}{{C}_{p , conv}} ) & ( 24 c )\end{matrix}$$

in which R_{obs} is the observed solute rejection, and C_{p,diff} and C_{p,conv} are the contributions of diffusive and convective marker transport (across the membrane), respectively, to the marker permeate concentration, whereby Cₚ=C_{p,diff}+C_{p,conv}. These contributions to the marker permeate concentration can be determined from a mass balance and Eqn. 19 recognizing that the marker flux due to diffusion (l_{v,diff}) and convection (l_{v,conv}) are the first and second terms on the RHS of Eqn. 19, respectively, hence

JᵥCₚ=J_{v,diff}C_{p,diff}+J_{v,conv}C_{p,conv}=B(Cₘ−Cₚ)+(1−σ)Jᵥ C̅ (25)

that is then solved for Cₚ:

$$\begin{matrix}{C}_{p} = {C}_{p , diff} + {C}_{p , conv} \\ = \frac{B ( {C}_{m} - {C}_{p} )}{{J}_{v}} + \overline{C} ( 1 - σ )\end{matrix} \qquad ( 26 )$$

where the first and second terms on the RHS of Eqn. 26 are identified with C_{p,diff} and C_{p,conv}, respectively.

Marker Passage Time Distribution (MPTD) Framework:

A marker passage time distribution (MPTD) is developed to characterize the extent and location of membrane integrity breach from the marker permeate response. In this framework, marker passage and rejection as well as the amount of time the marker resides in the membrane system are determined with considerations of the dynamic change in the marker concentration over time. Accordingly, at a given time t₁, the fraction of marker that passes across the membrane (MP) is determined as:

$$\begin{matrix}MP = \frac{{M}_{p , t 1}}{{M}_{f , t 1}} \\ = \frac{{\int }_{0}^{t 1} {m}_{p} ( t ) d t}{{\int }_{0}^{t 1} {m}_{f} ( t ) d t} \\ = \frac{{\int }_{0}^{t 1} {Q}_{p} {C}_{p} ( t ) d t}{{\int }_{0}^{t 1} {Q}_{f} {C}_{f} ( t ) d t}\end{matrix} \qquad ( 27 )$$

in which M_{p,t1} and M_{f,t1} denote the marker mass portions that passed through the membrane and injected into the feed, respectively. The terms mₚ(t), Qₚ, and Cₚ(t) are the rate of marker mass passage, permeate flow rate, and concentration, respectively, and m_{f}(t), Q_{f}, and C_{f}(t) are the rate of marker mass injection to the feed, RO feed flow rate, and marker feed concentration, respectively. Cₚ(t) is affected by the degree of convective transport across the membrane which would increase the MP with increasing breach size. It is noted that the observed marker rejection (by the membrane whether intact or compromised) can be determined from MP as given by:

R_{ob}=(1−MP)×100 (28)

where MP is determined by integration of the numerator in Eqn. 27 to a sufficiently long period until the monitored marker concentration in the permeate vanishes.

With the presence of a membrane breach, it is expected that the time the marker molecules spend in the membrane channel (or elements) will depend on the axial location of the breach along the flow channel. Therefore, one would expect a shift in the marker concentration-time profile with change in breach location and correspondingly a shift in the cumulative fraction of marker passage (CFMP) up to time t₁ specified as:

$$\begin{matrix}CFMP = \frac{{M}_{p , t 1}}{{M}_{p , ∞}} \\ = \frac{{\int }_{0}^{t 1} {m}_{p} ( t ) d t}{{\int }_{0}^{∞} {m}_{p} ( t ) d t} \\ = \frac{{\int }_{0}^{t 1} {Q}_{p} {C}_{p} ( t ) d t}{{\int }_{0}^{∞} {Q}_{p} {C}_{p} ( t ) d t}\end{matrix} \qquad ( 29 )$$

where M_{p,∞} is the total mass of the marker that passed to the permeate side during the entire marker monitoring period. It is noted that relationships between membrane breach characteristics (e.g., extent and location) and the MP and CFMP can be established by analyzing the characteristics of the marker permeate response.

### RESULTS AND DISCUSSION

Sensitivity of Pulsed Marker Approach for RO Membrane Breach Detection:

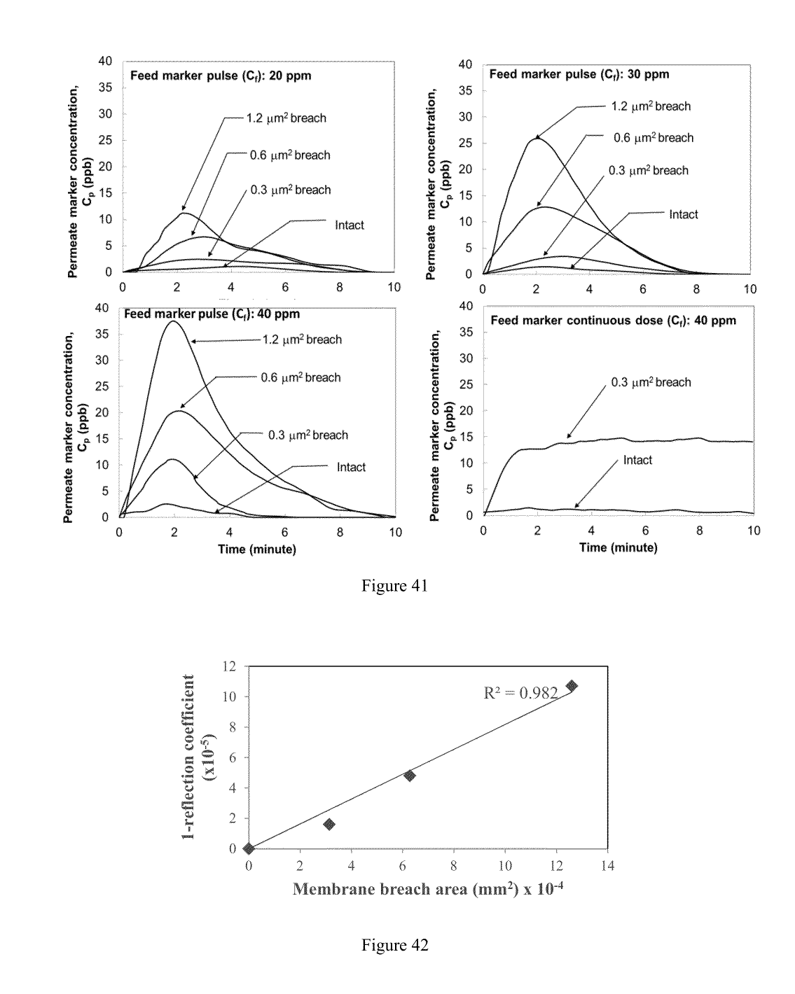

The suitability of the pulsed marker method for membrane breach detection was initially evaluated by monitoring marker permeate response through intact and compromised RO membranes in a PFRO system at various marker pulse feed concentrations. Marker permeate concentration for membranes with breach areas of about 0.3, about 0.6, and about 1.2 μm² was significantly higher for the breached relative to the intact membranes (FIG. 41). For all pulse marker inputs (about 20, about 30, and about 40 ppm of uranine), a higher marker peak concentration was detected with increased breach size. For example, for the about 40-ppm pulse input, the permeate marker concentration for the membrane with the breach area of about 1.2 μm² was about 3 times higher than that of the membrane with the breach area of about 0.3 μm². The increase in marker permeate concentration with the breached membrane area is attributed to the increase in the level of convective transport through the breached membrane locations, as indicated by a decrease in reflection coefficient (FIG. 42). It is noted that, although continuous marker dosing can provide reasonable degree of breach detection, it involves a high level of marker dose concentration over the monitoring period and as a result significantly higher mass input of the marker; the above is evident from the comparison of the marker permeate concentration for about 0.3 μm² breach (FIG. 41). However, marker pulsing involves a significantly lower amount of marker for injection into the RO feed in order to raise the marker permeate response to detectable levels, compared to the continuous marker dosing approach. Therefore, with marker pulsing, a high marker feed concentration can be utilized while minimizing or reducing marker consumption. Moreover, with the pulsed method one can ascertain more readily differences in the response profiles that are indicative of both the breach size and location when analyzed in terms of one or more of the MPTD, FTMP, MFP, MP, CFMP metrics.

Using the pulsed marker approach, high uranine LRV in the range of about 4-4.3 was established for the intact RO membrane. A decline in marker LRV was also observed with a breached membrane. Since waterborne pathogens (e.g., bacteria, protozoa, and viruses) are larger in size relative to uranine, their potential for passage through the intact membrane is lower than for uranine. Therefore, the expected LRV for pathogen removal will be higher than that which is measured, for the same membrane (intact or compromised) and for the marker. Accordingly, it can be concluded that the pulsed marker method at the detection limit of this example can demonstrate greater than about 4 LRV of pathogen in intact membranes in the PFRO system, and thus provide sufficient sensitivity for regulatory specifications.

Membrane Breach Characterization:

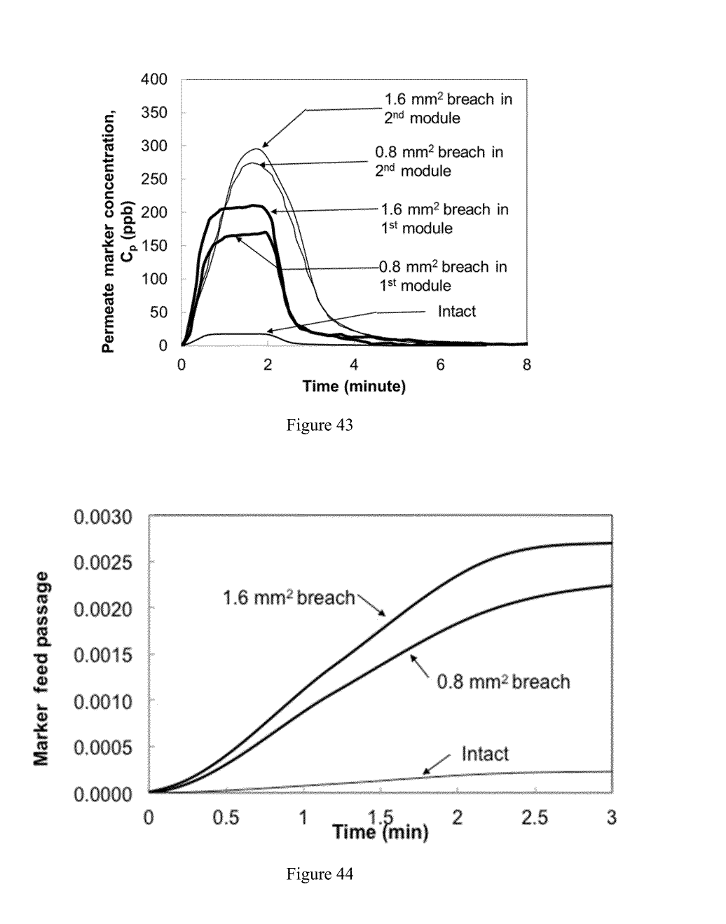

Since the effect of breach location on marker permeate response is marginal in the short PFRO membrane channel, but more significant for the longer SPRO membrane elements, monitoring of membrane integrity was also demonstrated using the pilot-scale SPRO system with intact and compromised SPRO elements with breached areas of about 0.8 and about 1.6 mm². As illustrated in FIG. 43, the loss of membrane integrity in the SPRO elements is readily discernable by comparing the marker concentration in the permeate for the breached relative to the intact membrane. The permeate marker concentration profile was affected by the breach location. As shown in FIG. 43, for the same breached area, the marker peak concentration was about 40-50% higher when the breach was located in the second (tail element in this example) RO element (about 108 cm away from the flow entrance) relative to a breach in the first element (about 7 cm away from the flow entrance). When membrane breaches are farther away from the flow entrance, increased permeate marker concentration at the membrane surface can be higher, in part, due to concentration polarization (CP). As water permeates through the membrane, the rejected solute accumulates near and at the membrane surface resulting in increased local marker concentration at the membrane surface, which is higher relative to the bulk solution, which further rises axially along the membrane train toward the flow exit. As illustrated in Table 2, the marker concentration at the membrane surface (Cₘ) for the second SPRO module (i.e., tail element in this example) is about 1.55 times higher than Cₘ in the first SPRO module. Consequently, higher Cₘ would result in a higher driving force for marker passage through the membrane toward the tail element of the RO treatment train, and thus higher marker concentration in the RO permeate.

TABLE 2
Marker concentration on the membrane surface (Cₘ) for each membrane
element as determined by Eqn. 23.

| | | Marker concentration |
|---|---|---|
| SPRO | Water | on membrane surface |
| Element | Recovery^{(a)} | (Cₘ), mg/L |
| First (lead) | 61.8% | 22.42 |
| Second (tail) | 37.2% | 31.74 |

^{(a)}Experimental conditions: feed flow rate = 1.6 gpm, marker feed concentration (C_{f}) = 20 mg/L

In order to characterize membrane integrity breaches, it is desirable to evaluate the impact of membrane breach size and location on marker permeate response independently. Evaluation of the characteristics of the marker permeate response via the MPTD demonstrated that the extent and location of the membrane breach can be quantitatively ascertained from the marker permeate response. Monitoring of the severity of membrane integrity loss via the MP-time profile (FIG. 44) for both the intact and compromised membranes demonstrates that a larger breach, at a given location, resulted in a higher MP as the plateau region of the MP-time profile is approached. This trend was observed when the membrane breach was located in both the first and second SPRO element (about 7 and about 108 cm away from the RO feed inlet, respectively). Determining MP also allows for the quantification of observed marker rejection. For example, by applying Eqn. 28 to the MP data in FIG. 44, the observed marker rejection was found to decrease from about 99.98% to about 99.64% when the membrane was intact to relative to when there was about 1.6 mm² breach in the membrane, respectively. Therefore, the severity of membrane breach can be ascertained by monitoring both the MP and observed marker rejection.

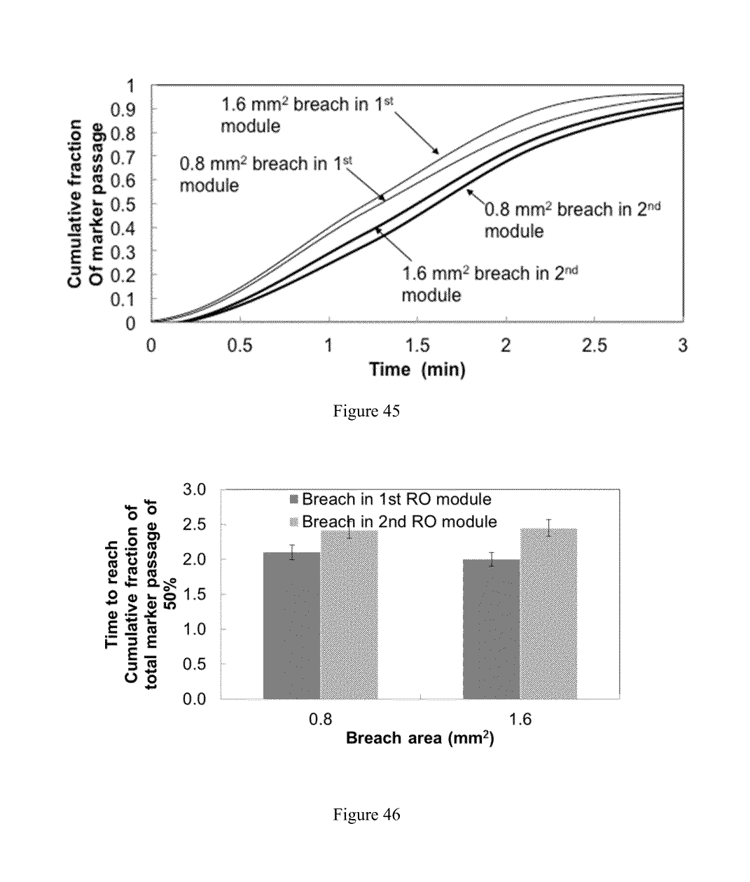

Monitoring the location of membrane integrity breach via the cumulative feed marker passage (CFMP)-time profile (the time dependence of the fraction of marker passage) as shown in FIG. 45 indicates that the membrane breach location can be readily determined using the current approach by comparing the CFMP profiles of the compromised membranes with breaches at various axial locations. For a given membrane breach area, as shown in FIG. 45, the CFMP profiles were shifted forward in time when the breach was in the tail (or second element in this example) SPRO element (about 108 cm away from flow entrance) compared to the breach in the lead (first in this example) SPRO element (about 7 cm away from flow entrance). A relationship between the location of a membrane breach and the CFMP can be established as shown in FIG. 46, where it is noted that the time to reach the CFMP of 50% was about 15-22% lower when the breach is located in the first SPRO (or lead in this example) element relative to a breach in the second (or tail in this example) SPRO element for the range of breach areas of 0.8-16 mm². The above approach should be useful for assessing the breach size and location, for a given plant, by comparing the CFMP profile with a library of CFMP profiles for the given plant obtained for breaches at different locations along the membrane train.

The CFMP-time profile is affected by the severity of the breach as well as the breach location as is evident in FIG. 45. Given the coupled effect of permeate flux distribution and breach severity and location, the CFMP representation of the marker response is useful for discerning breach location, while greater sensitivity of breach size detection is attained by comparing the MP-time profiles representing the percent marker passage relative to the injected mass (FIG. 44).

Assessment of Marker LRV Detection:

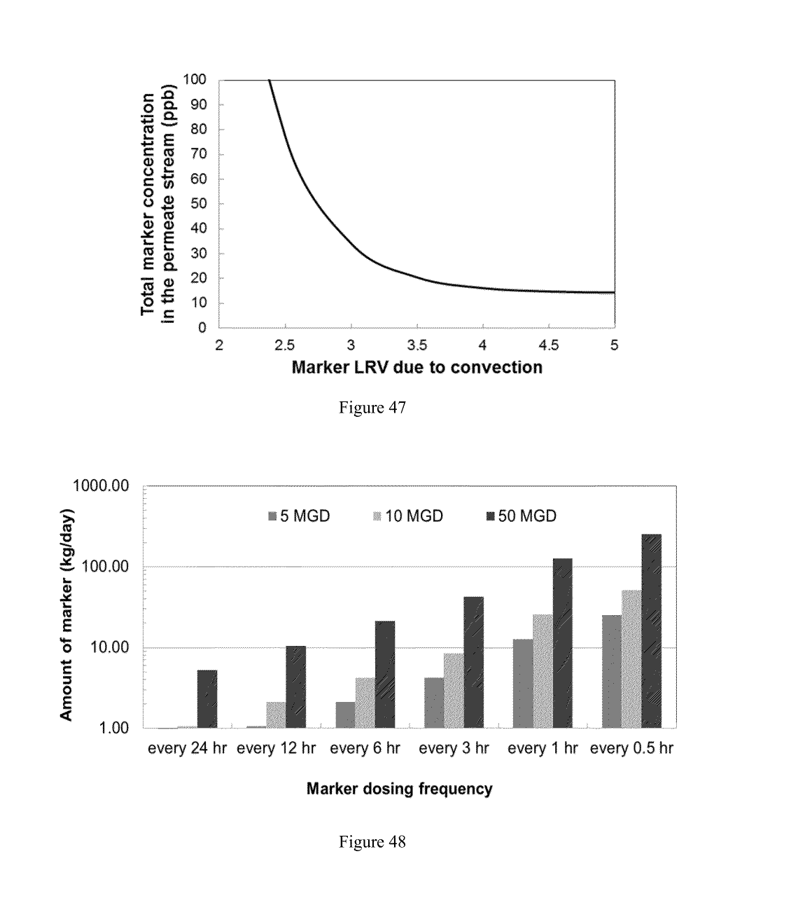

In order to assess the performance of a membrane with integrity loss via the pulsed marker method, it is desirable to assess the marker LRV through intact and compromised RO membrane elements in the SPRO system. Using the analysis above, LRVₒᵥₑᵣₐₗₗ as well as LRV_{conv} and LRV_{diff} were determined from the marker feed concentration and the peak concentration from the marker permeate response (FIG. 43). In Table 3, an increased level of marker convective transport across the compromised membranes is demonstrated by a decrease in a. As seen in Table 3, it is evident that, for compromised membranes, a decrease in σ has a direct impact on a decrease in both LRVₒᵥₑᵣₐₗₗ and LRV_{conv}, and that LRVₒᵥₑᵣₐₗₗ is nearly identical to LRV_{conv}, whereas LRV_{diff} is in the range expected for the intact membrane of this example. The above results indicate that the increased marker passage for compromised membrane is controlled by convective marker transport through breached membrane areas. It should be emphasized that, even though marker LRV for the tested intact SPRO membranes (Table 3) of this example is below 4, LRV greater than 4 can be demonstrated for intact membrane of higher solute rejection than the one used for the SPRO system in this example. Measurement of higher marker LRV for a high rejection membrane is possible given a sufficiently low marker concentration detection limit (e.g., detection limit of about 0.2 ppb in this example). For example, FIG. 47 shows that given the present intact membrane properties (e.g., B), the current SPRO flow conditions, and about 20 ppm uranine dosing in the feed stream, LRV_{conv} of about 4-6 can be attained when the permeate marker concentration is between about 14-16 ppb, which could be readily detected given the current spectrometer setup detection limit of about 0.2 ppb.

TABLE 3
Impact of membrane breaches on reflection coefficient and marker LRV
determined based on about 60-second pulse dosing of uranine to achieve
about 20 ppm uranine concentration in the SPRO feed^{(a)}.

| | Reflection | | | |
|---|---|---|---|---|
| | Coefficient | Marker | Marker | Marker |
| Membrane | (σ)^{(b)} | LRVₒᵥₑᵣₐₗₗ^{(c)} | LRV_{diff}^{(c)} | LRV_{conv}^{(c)} |
| Intact | 0.9997 | 3.05 | 3.15 | 3.74 |
| 0.8 mm² breach | 0.9882 | 2.10 | 3.15 | 2.14 |
| in the first | | | | |
| membrane element | | | | |
| 1.6 mm² breach | 0.9848 | 2.00 | 3.15 | 2.03 |
| in the first | | | | |
| membrane element | | | | |
| 0.8 mm² breach | 0.9797 | 1.88 | 3.15 | 1.90 |
| in the second | | | | |
| membrane element | | | | |
| 1.6 mm² breach | 0.9780 | 1.84 | 3.15 | 1.86 |
| in the second | | | | |
| membrane element | | | | |

^{(a)}SPRO system was operated at about 160 psi and feed flow rate of about 6.8 L/min (average cross flow velocity of about 12 cm/s)
^{(b)}B and σor the XLE-2540 membrane was pre-determined experimentally in the PFRO system with a flat sheet XLE-2540 membrane coupon. B was determined to have a value of 7.06 × 10⁻⁹ m/s.
^{(c)}Marker LRV was quantified via the analysis corresponding to Eqns. 24-26.

The sensitivity of the pulsed marker method for membrane breach detection was also compared to monitoring of other membrane performance data, including permeate flux and NaCl rejection (Table 4). In the presence of membrane breaches, the permeate flux increased by about 2.5-4.8%, whereas observed salt rejection varied from about 0.37% above to about 0.81% below the marker rejection for the intact system. The above variations in salt rejection were not systematic and essentially within the range of experimental variability of these measurements. The above results also indicate that monitoring of permeate flux and salt rejection is of insufficient sensitivity for detection of small integrity breaches. In contrast, monitoring of marker LRV via the pulsed marker method is superior to permeate flux and conductivity monitoring since it can reveal the presence of membrane integrity breach as well as allow estimation of the severity and location of membrane breaches.

TABLE 4
Observed salt rejection and permeate flux with and without the presence of
membrane integrity breaches in the SPRO membrane system^{(a)}.

| | Observed Salt | Permeate flux × 10⁻⁵ |
|---|---|---|
| Membrane condition | rejection (%) | (m³/m² s) |
| Intact | 96.45 | 1.20 |
| 0.8 mm² breach in the first | 96.82 | 1.24 |
| membrane element | | |
| 1.6 mm² breach in the first | 95.83 | 1.24 |
| membrane element | | |
| 0.8 mm² breach in the second | 96.15 | 1.26 |
| membrane element | | |
| 1.6 mm² breach in the second | 95.95 | 1.27 |
| membrane element | | |

^{(a)}SPRO system was operated with about 1,000 ppm NaCl solution at about 160 psi and feed flow rate of about 6.8 L/min (average cross flow velocity of about 12 cm/s). NaCl concentration in RO feed and permeate was measured via conductivity measurement.

Feasibility of the Pulsed Marker Approach for Deployment in Full-Scale RO Plant:

Monitoring of an entire membrane treatment train in RO plants using the present approach can reveal the presence of a membrane breaches and their possible locations through monitoring of different segments of a plant to isolate the general location (e.g., with respect to the tail or lead elements). This can be done by setting the detection system with a multiplexer or by integrating the PM-MIMo system for each RO membrane element or pressure vessel as deemed appropriate. Estimation of location and extent of the breach in a given vessel can be accomplished by monitoring specific element vessels and subsequently analyzing the marker response relative to the baseline for normal operation (e.g., intact membranes) in real-time. It is also possible to carry out calibration studies to determine marker response as a function of location and severity of a breach (e.g., by rotating a breached membrane to different location in the plant) and constructing a marker response library. The daily amount of marker would depend on the frequency of pulse dosing instances as illustrated in the example of FIG. 48 for three different membrane plant capacities.

### CONCLUSIONS

The pulsed marker method along with the marker permeation time distribution (MPTD) framework are suitable for detection and characterization of RO membrane integrity breaches or defects. The method involves pulsed dosing of a suitable marker into the RO feed stream coupled with real-time monitoring of marker concentration in the permeate stream by a high sensitivity, in-line detector. The pulsed marker method is capable of detecting the presence of RO membrane integrity breaches via monitoring of marker permeate concentration-time profile in response to a marker feed dose. Membrane breaches resulted in increased level of marker convective transport through the membrane (as indicated by the decrease in the reflection coefficient), and thus an increase in the marker permeate concentration. Assessment of the marker LRV indicated that the pulsed marker method can demonstrate greater than about 4 LRV of marker and viruses. The MPTD framework developed in this example can provide information on membrane breach size and position of the breach along the membrane treatment train. Testing of the pulsed-marker approach in a pilot-scale SPRO system revealed that both membrane breach extent and location have a measurable impact on the characteristics of the marker permeate concentration-time response profile. Using the MPTD framework, it was determined that for the SPRO system, the breach location and severity can be identified by monitoring the shift in the cumulative fraction of marker passage (CFMP)-time profile increasing level of marker passage (MP) at a prescribed monitoring period. However, since both the breach severity and location have an impact on the CFMP and MP profiles, a calibration for various breach areas and locations may be established specifically for each RO plant.

As used herein, the singular terms “a,” “an,” and “the” include plural referents unless the context clearly dictates otherwise. Thus, for example, reference to an object can include multiple objects unless the context clearly dictates otherwise.

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, the terms can refer to less than or equal to ±10%, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the terms “connect,” “connected,” and “connection” refer to an operational coupling or linking. Connected objects can be directly coupled to one another or can be indirectly coupled to one another, such as via another set of objects.

An embodiment of the disclosure relates to a non-transitory computer-readable storage medium having computer code thereon for performing various computer-implemented operations. The term “computer-readable storage medium” is used herein to include any medium that is capable of storing or encoding a sequence of executable instructions or computer codes for performing the operations, methodologies, and techniques described herein. The media and computer code may be those specially designed and constructed for the purposes of the invention, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs), and ROM and RAM devices. Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. A membrane integrity monitoring system comprising:
a metering unit fluidly connected to a feed side of a separation membrane unit, the metering unit configured to inject a marker into a feed stream via pulsed dosing;
a detection unit fluidly connected to a permeate side of the separation membrane unit, the detection unit configured to detect a marker signal in a permeate stream; and
a data acquisition and processing unit connected to the detection unit, the data acquisition and processing unit configured to process the marker signal and determine a presence of a membrane breach and at least one of (a) an extent of the membrane breach and (b) a location of the membrane breach in the separation membrane unit.

2. The membrane integrity monitoring system of claim 1, wherein the metering unit is configured to inject the marker into the feed stream via a pulse having a pulse duration of 20 min or less.

3. The membrane integrity monitoring system of claim 2, wherein the pulse duration is 10 min or less.

4. The membrane integrity monitoring system of claim 1, wherein the metering unit is configured to inject the marker into the feed stream via a pulse to attain a peak concentration of the marker in the feed stream of at least 5 ppm.

5. The membrane integrity monitoring system of claim 4, wherein the peak concentration of the marker in the feed stream is at least 10 ppm.

6. The membrane integrity monitoring system of claim 1, wherein the marker is a fluorescent marker, the detection unit is a spectrofluorometer unit, and further comprising a source of the fluorescent marker fluidly connected to the metering unit.

7. The membrane integrity monitoring system of claim 1, wherein the data acquisition and processing unit is configured to derive a marker response in the permeate stream based on the marker signal and compare the marker response to a set of reference responses to determine the presence of the membrane breach.

8. The membrane integrity monitoring system of claim 1, wherein the data acquisition and processing unit is configured to derive a first marker response in the permeate stream based on the marker signal, derive a different, second marker response in the permeate stream based on the marker signal, determine the presence of the membrane breach based on the first marker response, and determine at least one of (a) the extent of the membrane breach and (b) the location of the membrane breach based on the second marker response.

9. The membrane integrity monitoring system of claim 1, wherein the data acquisition and processing unit is configured to derive a first marker response in the permeate stream based on the marker signal, derive a different, second marker response in the permeate stream based on the marker signal, determine the extent of the membrane breach based on the first marker response, and determine the location of the membrane breach based on the second marker response.

10. The membrane integrity monitoring system of claim 1, wherein the data acquisition and processing unit is configured to derive the extent of the membrane breach based on the marker signal that is proportional to a concentration of the marker in the permeate stream and, based on the extent of the membrane breach, derive a passage potential of a pathogen or a contaminant through the separation membrane unit.

11. A water treatment system comprising:
a reverse osmosis (RO) membrane unit;
a metering unit fluidly connected to a feed side of the RO membrane unit, the metering unit configured to inject a marker into a feed stream;
a detection unit fluidly connected to a permeate side of the RO membrane unit, the detection unit configured to detect a marker signal in a permeate stream; and
a data acquisition and processing unit connected to the metering unit and the detection unit, the data acquisition and processing unit configured to direct the metering unit to inject the marker into the feed stream as a pulse, the data acquisition and processing unit configured to, based on the marker signal, determine a presence of a membrane integrity loss in the RO membrane unit.

12. The water treatment system of claim 11, wherein the pulse has a pulse duration of 20 min or less.

13. The water treatment system of claim 11, wherein the pulse has a magnitude to attain a peak concentration of the marker in the feed stream of at least 5 ppm.

14. The water treatment system of claim 11, wherein the marker is a fluorescent marker, the detection unit is a spectrofluorometer unit, and the marker signal is a fluorescent signal.

15. The water treatment system of claim 11, wherein the data acquisition and processing unit is configured to derive a marker response in the permeate stream based on the marker signal and compare the marker response to a set of reference responses to determine the presence of the membrane integrity loss.

16. The water treatment system of claim 11, wherein the data acquisition and processing unit is configured to derive a marker response in the permeate stream based on the marker signal and compare the marker response to a set of reference responses to determine a severity of the membrane integrity loss.

17. The water treatment system of claim 16, wherein the data acquisition and processing unit is configured to determine a passage potential of a pathogen or a contaminant through the RO membrane unit, based on the severity of the membrane integrity loss.

18. The water treatment system of claim 11, wherein the data acquisition and processing unit is configured to derive a marker response in the permeate stream based on the marker signal and compare the marker response to a set of reference responses to determine a location of the membrane integrity loss in the RO membrane unit.

19. The water treatment system of claim 11, wherein, responsive to a positive indication of the membrane integrity loss based on a marker response in the permeate stream due to a first pulse of the marker in the feed stream, the data acquisition and processing unit is configured to trigger a subsequent pulse of the marker to confirm the positive indication of the membrane integrity loss.

20. The water treatment system of claim 19, wherein the subsequent pulse has a higher marker concentration than the first pulse.
